(19) United States
(12) Patent Application Publication
(10) Pub. No.: US 2016/0270303 A1
(43) Pub. Date: Sep. 22, 2016

(54) FLOATING PLANT PROPAGATION TRAY

(71) Applicant: Beltwide, Inc., Tampa, FL (US)

(72) Inventors: John N. Cooley, Gargrave (GB); Charles G. Miglianti, Tampa, FL (US)

(21) Appl. No.: 15/070,177

(22) Filed: Mar. 15, 2016

Related U.S. Application Data
(60) Provisional application No. 62/133,646, filed on Mar. 16, 2015.

(51) Int. Cl. A01G 9/10

(52) U.S. Cl. CPC A01G 9/104

(57) ABSTRACT

A floating plant propagation tray is supported by a body of fluid. The floating plant propagation tray comprises a tray plate, a tray wall and a plurality of soil cells. The proximal end of the plurality of soil cells define an upper soil cell aperture for receiving a soil and a plurality of seeds and/or a plurality of seedlings. The distal end of the plurality of soil cells include a lower soil cell aperture for inputting a portion of the body of fluid into the soil cell chamber. The plurality of soil cells extend within a tray chamber for defining a tray volume. The plurality of soil cell chambers define a cell volume. The cell volume and the tray volume define a buoyant equilibrium condition for supporting the floating plant propagation tray, the soil and the plurality of seeds and/or a plurality of seedlings within the body of fluid.

### BACKGROUND OF THE INVENTION

1. Field of the Invention

This invention relates to a plant growth tray and more particularly to a floating plant growth tray.

2. Background of the Invention

Plants are typically propagated in the horticultural industry from seeds, cuttings, tissue culture plantlets, etc (propagule) and propagated in specialist trays designed to produce the best quality plant most economically. These trays are typically divided into individual compartments to hold the soil (this can be peat, coir or many other types of substrate) and with a drain hole in the bottom of each compartment or cell. The trays are typically filled with soil and then the propagule is placed in the tray from which the transplant is grown. Plants are then removed from the tray and transplanted into a larger container or in the case of vegetable plants, tobacco plants, etc planted in the field soil. Some plant propagation systems use a float system where the propagation tray is floated in a contained water reservoir and thus water enters the cell through the drain hole to give the plant its water and fertilizer. With this system the tray has to float and to date EPS trays (expanded polystyrene trays) have been used as they are naturally very buoyant.

The expanded polystyrene trays have become the standard globally in a lot of commercial large scale float propagation systems but have significant disadvantages such as:

a) are very difficult to sterilize;

b) methyl bromide which has been used for sterilizing these trays successfully in recent decades has now been banned globally therefore sterilization is now a much bigger issue than it was in the early days of EPS use;

c) whilst cheaper at purchase time are expensive in the long term as they need to be replaced frequently especially now sterilization is more difficult;

d) beads from the trays can break off and get into the final product with crops like tobacco which is known to be a significant problem in processing plants.

These disadvantages are significant and the expanded polystyrene trays continue to be used only because there has been no alternative. In addition, following the end of usefulness of the trays, disposal of expanded polystyrene trays results in environmental concerns, as is well known to those skilled in the art.

There have been many in the prior art who have attempted to solve these problems with expanded polystyrene trays with varying degrees of success. None, however completely satisfies the requirements for a complete solution to the aforestated problem. The following U.S. patents are attempts of the prior art to solve this problem.

U.S. Pat. No. 2,531,562 to Eve discloses a floral buoy for supporting containers for growing plants in pools. A buoyant body is adapted to float on the surface of water. The body is formed with a plurality of normally vertical bores extending therethrough to receive the plant containers. The plant containers extend through the bores and project into water below the buoyant body while being supported thereby.

U.S. Pat. No. 3,667,159 to Todd discloses a seedling flat in the form of a unitary plastic member having downwardly extending square tapered soil receiving recesses in which individual seedlings are started. One embodiment employs a unitary polystyrene foamed plastic; and a second embodiment is embodied in a construction formed of rigid plastic plate members connected together in a unitary manner.

U.S. Pat. No. 4,037,360 to Farnsworth discloses an apparatus for growing plants by means of water culture or hydroponics. The apparatus includes raft means formed to receive and support the plants on a nutrient solution with their root systems extending therethrough while they grow to maturity. The rafts are formed for positioning in close proximity during all stages of plant growth to maximize the plant density per unit area of the solution. The rafts are preferably constructed for seed germination as well as for growth of seedlings to mature plants. Buoyancy of the rafts is increased during plant growth by placing a small raft on a larger raft or auxiliary buoyancy means.

U.S. Pat. No. 4,058,931 to Vestergaard discloses a plant cultivation and support structure in the form of a strongly hygroscopic block having a flat base. An indentation is located in the top, large enough to hold a seed or a seed pellet. An open bore leads from the bottom of the indentation to the base. At least one transverse channel extends clear through the block at the base. A plurality of blocks may be formed in rows and columns of an integral plate subdivided by mutually perpendicular sets of spaced narrow congruent grooves in the top and bottom surfaces of the plate. The material of the plate is a foamed light, brittle plastic having an elongated tandem cell structure with porous walls, a pH value not exceeding 5.2, and specific gravity between 3 and 15 kg/m.sup.3.

U.S. Pat. No. 4,312,152 to Drury, et al. discloses a support structure for growing plants such as lettuce by hydroponic cultivation including a buoyant, closed cell, foamed plastic pallet having an array of spaced integral punch-out plugs arranged preferably in staggered rows. Selected patterns of plugs are removed to permit insertion of plants growing in porous seed blocks into the resulting holes. The patterns have different spacings depending on the size of the plants. Blocking members prevent the plants from falling through the holes when the pallets float on liquid nutrient solution in a trough and also space the pallets above the bottom of the trough for access of air to the plant roots when the trough is periodically drained. When plants outgrow one selected spacing pattern, they are readily and precisely transferred to another pallet having a selected pattern of greater spacing. When the plants are ready for harvesting, the pallets with mature plants in them can be carried to a packaging area.

U.S. Pat. No. 4,382,348 to Kitsu, et al. discloses a reusable soilless plant growing device in which plants can be grown from seeds and in which, irrespective of any increase or decrease in the quantity of nutrient solution, the plants remain in contact with the solution. The peripheral portion of a porous plate is fixedly secured to a buoyant frame. The buoyancy of the porous plate and frame together are such that the porous plate is positioned at least in contact with the surface of the nutrient solution when the device is floated thereon. A hollow chamber in the frame may be filled with a highly buoyant material. The position of the porous plate relative to the surface of the nutrient solution is adjustable in several of the described embodiments.

U.S. Pat. No. 4,389,814 to Andreason, et al. discloses a reusable seedling transplant unit for elevated growing, by germinating several seedlings simultaneously in a growth medium, contains a plurality of pot-shaped cells all joined together. Each cell has an open top and bottom and is structured with a plurality of ribs extending downwardly from the open cell top to converge to the bottom. The ribs are closely spaced forming narrow slits therebetween so as to retain the growth medium in the cell during elevated growing and during transportation to a site, e.g., for reforestation. The ribs can be resiliently deformed to release each seedling for replanting in soil along with its root lump and associated growth medium, without detrimentally affecting the root lump.

U.S. Pat. No. 4,468,885 to Mandish discloses a floating hydroponic apparatus along with a hydroponic system using the hydroponic apparatus. The floating hydroponic apparatus has a floating hydroponic tray having a floating base portion and a tray portion. The floating base portion is made of a lightweight cement and has floating perimeter walls along with a polymer screen attached between the floating base portion and the tray portion. The floating base portion and tray portion form a plurality of openings therethrough for the passage of liquid. An alkaline resistant coating is applied to at least a portion of the tray. The tray portion is filled with a soil mixture supported by the polymer screen so that plants can be grown in the soil in the trays while the trays are floating upon a liquid reservoir. The trays can be used in conjunction with a hydroponic system having pools with specially designed lightweight concrete walls forming a habitat for marine life.

U.S. Pat. No. 4,586,288 to Walton discloses a novel tissue culture assembly which employs a tray that presents one or more cavities opening upwardly through a web sheet. A unique growing medium is received in each cavity and comprises a mixture of granulated foam and pulverized gel. A membrane spans the opening of each cavity and is secured to the tray. An aperture pierces the membrane at approximately the central portion of the cavity opening, or mouth. The sides of the aperture engage a propagule inserted through the aperture to support the propagule. The base of each cavity is provided with an apertureby which selected fluids may gain ingress and egress with respect to the cavity. A domed cover may be removably secured to the tray.

U.S. Pat. No. 4,607,454 to Koike discloses a floating bed useful for hydroponically germinating seeds of a plant and growing the germinated sprouts thereon. The floating bed is floatable by itself on water and includes a pad formed of a hydrophobic material such as foamed polystyrene and provided with one or more through holes. The through holes have a size so that it can continually retain water therein by capillary attraction during the float of the bed on water. The seeds are placed on the pad and the floating bed is floated on the surface of water to allow the seeds to germinate and the germinated sprouts to grow with the roots thereof passing through the through holes.

U.S. Pat. No. 4,622,775 to Glenn, et al. discloses collars, for supporting plants by the base of their stems with the major portion of the root structure extending downward into an aqueous hydroponic medium, have upstanding sidewalls and bottom end structures that support the plant while leaving at least about 75 percent of the bottom area open for the roots to extend through. The collars are very small having a volume less than about one tenth that which would normally be considered adequate to conventionally culture plants in a solid support medium. Vertical foils extend radially inward from the sidewall to prevent the roots, in their early stages of development, from spiraling around the sidewall.

U.S. Pat. No. 4,671,699 to Roach discloses a modular system of rectangular pavers which can be laid down across a grass area to support foot or vehicle traffic while permitting grass to grow through apertures in the pavers. Each paver is made up of a base plate having a rectangular grid of upstanding walls secured thereto. An aperture is provided through the base plate within each grid cell. The maximum distance between opposite walls in each cell is about one inch. Typically, the pavers will have thicknesses of up to about one inch. The base plates extend slightly beyond the edge of the grid on two sides, with the grid extending the same distance beyond the base plate on the other two sides so that a plurality of pavers can be assembled in a contiguous overlapping relationship. Abutting pavers may be secured together, such as by staples. To hold the assembly in place, anchoring spikes are provided having a rectangular head corresponding to the interior area of the bottom of each cell and an elongated, pointed shaft. The spike is forced into the soil through one of the apertures until the head contacts the bottom of the cell. The pavers are preferably formed from high density polyethylene or a similar material.

U.S. Pat. No. 4,769,946 to deGroot, et al. discloses a transplant tray comprising a number of germination cells, each cell including side walls for holding and retaining a growth medium and seeds or seedlings for germination. Each cell has an opening at the top for retrieval of the growth medium and seedlings for transplanting after germination. The cells are connected to or are integral with one another forming a planar structure. The tray further comprises a skirt connected to or integral with the perimeter of the planar structure. When two trays are stacked the skirts of the two trays are nested within each other thereby enclosing the space between the two trays forming a germination chamber. Vent holes of appropriate sizes are provided in the skirts permitting limited and controlled gas exchange between the germination chamber and the environment to enhance the uniformity of germination conditions within the chamber. The vent holes are not so large as to cause significant loss of moisture to an uncontrolled environment. Stand-offs maintain a desired separation between trays when stacked to prevent undesirable disturbance and scraping off of growth medium and seeds. The skirt is slightly tapered to permit nesting of trays, whether empty or full.

U.S. Pat. No. 4,926,584 to Horinbata discloses a method for hydroponics comprising submerging the lower region of a bulb and its hair roots for a selected period of time and for another selected period of time, lifting the bulb out of the water to expose to air the lower region of the bulb and an upper portion only for the hair roots of the bulb. An aquatic float comprises a vessel having a floatable coaster in juxtaposition thereto, means temporarily securing the coaster to the vessel and a seed or bulb bed means disposed at least at one end of the vessel, the seedbed means including a plurality of passages through the walls of the vessel.

U.S. Pat. No. 5,324,657 to Tanny discloses an apparatus for plant cell tissue culture including a plant growth enclosure having a bottom surface formed of a porous material. A buoyant element is provided, separate from the plant growth enclosure and arranged to be placed thereunder in a body of liquid for supporting the plant growth enclosure. A spacer apparatus is associated with at least one of the plant growth enclosure and the buoyant element for maintaining a predetermined separation between the buoyant element and the porous material.

U.S. Pat. No. 5,435,098 to Koide, et al. discloses a water culture apparatus wherein air space sections are formed between plant containers and a nutrient solution when rafts are floated in a water culture tank filled with the nutrient solution. The plant containers are inserted in vertically oriented channels provided in the raft. The air space sections are formed in order that the plant containers do not get submerged in the nutrient solution. The plants are cultivated by: gradually moving the raft from one end to another end of the water culture tank, movement of the raft corresponding to a state of growth of the plants so that the plants supported by the plant containers reach the other end by the time the plants have grown as a result of having absorbed nutrients from the nutrient solution; and harvesting the plants when each of the rafts reaches the other end of the water culture tank. The plants are handled by sowing several seeds into each of the plant containers. The seeds in each of the plant containers correspond in number to a shipping unit of the plants. Plant containers are prepared along with the plants contained therein for shipping once the plants have grown.

U.S. Pat. No. 5,836,108 to Scheuer discloses a floating planter box comprising a polyhedral planar base member of a synthetic foam resin less dense than water. A pair of frame members sandwich the base member with one on the top and one on the bottom surface thereof. Side members surround the frames and base member and connect the frame members to hold the base member between the frames. The lower frame member has optional bracing members to strengthen that member. The planter displaces sufficient water to float the unit with the contained volume formed by the top surface and side members filled with soil and plants. An optional anchoring means hold the planter in place on a water surface.

U.S. Pat. No. 5,934,018 to Thomas discloses a molded plant tray in the form of a unitary molded plastic member formed of relatively light foamed plastic and having downwardly extending tapered plant cells for receiving plating medium in which individual seedlings are crown. The plastic member is provided with a plurality of parallel, U-shaped indexing rod-receiving grooves defined on the bottom surface of the plastic member by portions of the intermediate walls that define the plant cells. The indexing rod-receiving grooves are complementary in shape to a plurality of indexing rods arranged in parallel spaced relation in a drum shape rotatable about a longitudinal axis and spaced to receive the indexing rods as they rotate about the longitudinal axis. A U-shaped alignment member-receiving groove is also provided, and is defined on the bottom surface of the plastic member by portions of the intermediate walls to extend perpendicular to the central axes of the indexing rod-receiving grooves. The alignment member-receiving groove is complementary in shape to a ring extending around the perimeter of the drum shape.

U.S. Pat. No. 6,014,838 to Asher discloses a buoyant apparatus for floating plants and other foliage in ponds. It is directed to a floating support or raft for one or more plant pots. Such materials are attractive to fish and other aquatic animals frequently present in such decorative ponds. In the floatable foliage pots herein the floating base or collar is protected so that it cannot be chewed, and ruined by aquatic animals. A mesh screen is adapted to cover exposed surfaces of the collar to prevent fish from biting it.

U.S. Pat. No. 6,085,462 to Thomas discloses a molded plant tray in the form of a unitary molded plastic member formed of relatively light foamed plastic and having downwardly extending tapered plant cells for receiving planting medium in which individual seedlings are grown. The plant tray is provided with integral drive member receiving groove means in the form of U-shaped grooves along bottom portions of intermediate walls that define the plant cells. An alignment groove can also be provided perpendicular to the drive member receiving groove means and bisecting the length of the drive member receiving groove means for accurate positioning of the plant tray relative to drive members. In a second embodiment a relatively hard plastic insert is molded, manufactured or adhesively secured to create a dual body tray in the molded plastic member and defines the plant cells.

U.S. Pat. No. 6,233,870 to Horibata discloses a method and device for aquatic greening in a space of a structure including a storage tank for a cultivating fluid, pump and pipes for circulating the cultivating fluid in a prescribed concentration and flow to a cultivating device, a tank for collecting the cultivating fluid drained from the cultivating device wherein the drained cultivating fluid may be filtered and neutralized or diluted. The cultivating fluid may be a fertilizer fluid or water or a mixture thereof. Electric power for operation may be provided by a solar energy source. The operation of the method and device may be controlled by a computer located in the structure or an adjacent structure. Air may be blown partially or thoroughly into the cultivating fluid. A mesh or net or wires, which may form a trellis and which may be attached to the structure, is adjacent the cultivating device and assist in the growth of the aquatic greening.

U.S. Pat. No. 6,786,002 to Prescott discloses a floatable planter employed in a body of water, such as a fish pond, in order to prevent the growth of algae. The planter employs an aquatic pot for receiving a plant, a peat pot having a planting medium for receiving the aquatic pot, a flotation ring about the aquatic pot, a mass of decomposable material selected from the group consisting of barley straw and lavender, and a mesh bag that envelopes the pots, flotation ring and decomposable material. As the decomposable material decomposes, hydrogen peroxide is produced in order to act as an algaecide in the body of water. The flotation ring ensures the proper flotation of the straw or lavender in the water.

U.S. Pat. No. 6,843,021 to Huang discloses a floatable plant cultivation device including a plurality of hollow floatable parts. Each floatable part has a pot engaged with a first passage in a center of the floatable part. The pot receives a plant therein. The multiple floatable parts are connected with each other by a plurality of connection members. Each connection member includes several engaging ends which are engaged with second passages defined in different floatable parts.

U.S. Pat. No. 6,918,206 to Schuck discloses an improved floating island planting system comprising a float ring formed as a circular walled member of closed-cell polyethylene foam, and a garden planter formed in a bowl configuration with a collar of greater diameter than the float ring. The bowl of the garden planter is dimensioned for nesting in the float ring, the planter is defined by a plurality of holes through the closed bottom. A fill mix comprising a combination of clay and potting soil resides in the planter. An alternate embodiment is shown in which the planting system is integrally formed from an open-ended circular collar section that is heat sealed to a conforming circular base section.

U.S. Pat. No. 7,320,197 to Meyer discloses a floating garden device for displaying and watering at least one living plant as the garden floats on a body of water. The device is composed of a buoyant body and at least one plant mounting recess attached to the buoyant body. The recess is comprised of a sidewall and a bottom. The bottom is positioned in a non-horizontal orientation, generally forming an angle between five degrees and forty-five degrees. The recess is located such that only a portion of the bottom is in fluid communication with the water, thus not submerging the entire bottom. The garden device may have at least one fluid passageway extending through the mounting recess bottom such that the water may fill the submerged portion of the mounting recess, or it may have a wicking device attached to the recess bottom such that the wicking device extends into the water.

U.S. Pat. No. 7,448,163 to Beeman, et al. discloses a floatable plant cultivation system that comprises a plurality of buoyant bases secured together and float on a water surface. One or more of the bases includes means for supporting one or more plants. The bases have side edges that abut one another and are secured together. In a preferred embodiment, the bases are rectangular mats fabricated from a closed-cell foam plastic material. Each of the bases has at least one side edge wherein a plurality of indentations are spaced apart along the side edge forming a plurality of protrusions and each indentation is positioned between consecutively spaced protrusions. The side edges of respective bases are joined together such that the protrusions on one base are positioned in mating relationship with the indentations of another base. In addition, or alternatively, the bases can be secured together by clips.

U.S. Pat. No. 8,707,620 to Miller, et al. discloses a seedling tray including a top body member constructed of a rigid solid plastic material having a plurality of planting cells formed in an upper surface with each of the cells converging downwardly and inwardly to define an opening at the bottom thereof. A plurality of air chambers are formed between adjacent ones of the cells which are closed at the bottom by a bottom plate member constructed of a rigid plastic material which is fixedly attached to the body member and which has openings therein corresponding in number and alignment with the openings of the bottoms of the cells which are sealingly engaged with the openings in the bottom plate member.

U.S. Pat. Design No. D277,467 to Turunen discloses an ornamental design for a multiple plant container, as shown.

U.S. Pat. Design No. D540,711 to Howard, et al. discloses an ornamental design for a seedling tray, as shown and described

United States Patent Application 2008/0120903 to Fair, et al. discloses a floatable growth tray for the germination of seedlings having a plurality of cells adapted to receive a mixture of a growth median and seeds. The tray has sealed pockets forming air chambers to enable the tray to float. The cells have holes forming openings extending through a bottom surface of the tray permitting water to enter the cells to promote germination of the seeds.

Although the aforementioned prior art have contributed to the development of the art of plant float systems none of these prior art patents have solved the needs of this art.

Therefore, it is an object of the present invention to provide an improved tray for a plant propagation flotation system.

Another object of this invention is to provide a plant propagation flotation system tray that is not constructed from EPS (expanded polystyrene trays).

Another object of this invention is to provide a plant propagation flotation system tray that is for the propagation of plants.

Another object of this invention is to provide a plant propagation flotation system tray that floats.

Another object of this invention is to provide a plant propagation flotation system tray that is constructed from on integral one piece unit.

Another object of this invention is to provide a plant propagation flotation system tray that provides improved flotation stability.

Another object of this invention is to provide a plant propagation flotation system tray that is easily sterilized.

Another object of this invention is to provide a plant propagation flotation system tray that is easy to cost effectively produce.

Another objective of this invention is to provide a plant propagation flotation system tray that is self-leveling.

Another objective of this invention is to create a plant propagation flotation system tray that has much less negative environmental impact as first the tray can be recycled after its useful life and second is not difficult and dangerous to dispose of in the way that EPS trays are.

Another objective of this invention is to provide a plant propagation flotation system tray that is better suited to the future of plant propagation nurseries in terms of automation and mechanization.

Another objective of this invention is to provide a plant propagation flotation system tray that can be used in place of the EPS tray with minimal or no change to the propagation nurseries normal way of propagating plants i.e. the tray can simply be swapped over to replace the EPS tray.

The foregoing has outlined some of the more pertinent objects of the present invention. These objects should be construed as being merely illustrative of some of the more prominent features and applications of the invention. Many other beneficial results can be obtained by modifying the invention within the scope of the invention. Accordingly other objects in a full understanding of the invention may be had by referring to the summary of the invention, the detailed description describing the preferred embodiment in addition to the scope of the invention defined by the claims taken in conjunction with the accompanying drawings.

### SUMMARY OF THE INVENTION

The present invention is defined by the appended claims with specific embodiments being shown in the attached drawings. For the purpose of summarizing the invention, the invention relates to a floating plant propagation tray for supporting soil. The soil contains a plurality of seeds and/or a plurality of seedlings. The floating plant propagation tray is supported by a body of fluid. The floating plant propagation tray comprises a tray plate including an upper surface, a lower surface and a peripheral edge. A tray wall includes an exterior surface, an interior surface, a proximal edge and a distal edge. The proximal edge of the tray wall is coupled to the peripheral edge of the tray plate. The tray plate and the tray wall define a tray chamber. A plurality of soil cells include a tapering cross section extending between a proximal end and a distal end. The proximal end of the plurality of soil cells are coupled to the lower surface of the tray plate and define an upper soil cell aperture. The plurality of soil cells define a soil cell chamber for receiving the soil and the plurality of seeds and/or a plurality of seedlings through the upper soil cell aperture. The distal end of the plurality of soil cells include a lower soil cell aperture for inputting a portion of the body of fluid into the soil cell chamber. The plurality of soil cells extend within the tray chamber for defining a tray volume within the tray plate, the tray wall and around the plurality of soil cells. The plurality of soil cell chambers define a cell volume. The cell volume and the tray volume define a buoyant equilibrium condition for supporting the floating plant propagation tray, the soil and the plurality of seeds and/or a plurality of seedlings within the body of fluid.

In a more specific embodiment of the invention, the tray wall and the plurality of soil cells displace the body of fluid and define a trapped air volume within the tray plate, a portion of the tray wall and around a portion of the plurality of soil cells. The cell volume and the trapped air volume have a ratio between 1 to 1, 1 to 2, 1 to 3, 1 to 4, 1 to 5 or 1 to 6.

In a more specific embodiment of the invention, the tray wall includes a front side wall, a rear side wall, a primary side wall and a secondary side wall. A plurality of primary bulkheads extend between the front side wall and the rear side wall for defining a plurality of primary air chambers within the tray chamber. A plurality of secondary bulkheads extend between the primary side wall and the secondary wall for defining a plurality of secondary air chambers within the tray chamber. The plurality of primary bulkheads and the plurality of secondary bulkheads define a grid of air chambers including a plurality of individual row air chambers and a plurality of individual column air chambers. The grid of air chambers resist air from departing from the tray chamber upon the tray plate having a non-parallel position relative to the body of fluid.

In a more specific embodiment of the invention, the tray wall has a wall height. The plurality of soil cells have a cell height. The cell height includes a less than dimension to the wall height for increasing the tray volume and reducing the plurality of soil cells displacement within the body of fluid. The less than dimension has a range between 1 mm and 25 mm.

The foregoing has outlined rather broadly the more pertinent and important features of the present invention in order that the detailed description that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be made to the following detailed description taken in connection with the accompanying drawings in which:

FIG. 1 is an upper front isometric view of a first embodiment for a floating plant propagation tray;

FIG. 2 is a lower rear isometric view of FIG. 1;

FIG. 3 is a top view of FIG. 1;

FIG. 4 is a front view of FIG. 1;

FIG. 5 is a left side view of FIG. 1;

FIG. 6 is a bottom view of FIG. 1;

FIG. 7 is a sectional view along line 7-7 in FIG. 6;

FIG. 8 is a sectional view along line 8-8 in FIG. 6;

FIG. 9 is a view of the floating plant propagation tray of FIG. 1 including a plurality of seedlings and the floating plant propagation tray being supported by a body of fluid;

FIG. 10 is a sectional view along line 10-10 in FIG. 9 illustrating the floating plant propagation tray having a buoyant equilibrium condition within the body of fluid;

FIG. 11 is a view similar to FIG. 10 illustrating the floating plant propagation tray resisting air from departing from below the floating plant propagation tray during a non-parallel position relative to the body of fluid;

FIG. 12 is a sectional view along line 12-12 in FIG. 9 illustrating the floating plant propagation tray having a buoyant equilibrium condition within the body of fluid;

FIG. 13 is a view similar to FIG. 12 illustrating the floating plant propagation tray resisting air from departing from below the floating plant propagation tray during a non-parallel position relative to the body of fluid;

FIG. 14 is an upper front isometric view of a second embodiment for a floating plant propagation tray;

FIG. 15 is a lower rear isometric view of FIG. 14;

FIG. 16 is a top view of FIG. 14;

FIG. 17 is a front view of FIG. 14;

FIG. 18 is a left side view of FIG. 14;

FIG. 19 is a bottom view of FIG. 14;

FIG. 20 is a sectional view along line 20-20 in FIG. 19;

FIG. 21 is a sectional view along line 21-21 in FIG. 19;

FIG. 22 is a view of the floating plant propagation tray of FIG. 14 including a plurality of seedlings and the floating plant propagation tray being supported by a body of fluid;

FIG. 23 is a sectional view along line 23-23 in FIG. 22 illustrating the floating plant propagation tray having a buoyant equilibrium condition within the body of fluid;

FIG. 24 is a view similar to FIG. 23 illustrating the floating plant propagation tray resisting air from departing from below the floating plant propagation tray during a non-parallel position relative to the body of fluid;

FIG. 25 is a sectional view along line 25-25 in FIG. 22 illustrating the floating plant propagation tray having a buoyant equilibrium condition within the body of fluid;

FIG. 26 is a view similar to FIG. 25 illustrating the floating plant propagation tray resisting air from departing from below the floating plant propagation tray during a non-parallel position relative to the body of fluid;

FIG. 27 is a view similar to FIG. 10 illustrating the level initial contact between the tray and the water;

FIG. 28 is a view similar to FIG. 27 illustrating the displacement of the tray within the water;

FIG. 29 is a view similar to FIG. 28 illustrating the further displacement of the tray within the water,

FIG. 30 is a view similar to FIG. 29 illustrating the equilibrium or buoyant position of the tray relative to the water,

FIG. 31 is a view similar to FIG. 27 illustrating the non-level initial contact between the tray and the water;

FIG. 32 is an enlarged left portion of FIG. 31;

FIG. 33 is an enlarged right portion of FIG. 31;

FIG. 34 is the tray of FIG. 31 illustrating the displacement of the tray within the water and leveling of the tray related to the water;

FIG. 35 is a view similar to FIG. 31 illustrating different amount of air in each chamber below the tray and resulting in an initial non-level orientation between the tray and water;

FIG. 36 is an enlarged left portion of FIG. 35;

FIG. 37 is an enlarged right portion of FIG. 35;

FIG. 38 is the tray of FIG. 35 illustrating the displacement of the tray within the water and leveling of the tray related to the water;

FIG. 39 is a view similar to FIG. 35 illustrating air escaping from each chamber below the tray and resulting in a non-level orientation between the tray and water;

FIG. 40 is the tray of FIG. 39 illustrating the displacement of the tray within the water and leveling of the tray related to the water;

FIG. 41 is an upper front isometric view of a third embodiment for a floating plant propagation tray;

FIG. 42 is a lower rear isometric view of FIG. 41;

FIG. 43 is a top view of FIG. 41;

FIG. 44 is a front view of FIG. 41;

FIG. 45 is a left side view of FIG. 41;

FIG. 46 is a bottom view of FIG. 41;

FIG. 47 is a sectional view along line 47-47 in FIG. 46;

FIG. 48 is a sectional view along line 48-48 in FIG. 46;

FIG. 49 is a view of the floating plant propagation tray of FIG. 41 including a plurality of seedlings and the floating plant propagation tray being supported by a body of fluid;

FIG. 50 is a sectional view along line 50-50 in FIG. 49 illustrating the floating plant propagation tray having a buoyant equilibrium condition within the body of fluid;

FIG. 51 is a view similar to FIG. 50 illustrating the floating plant propagation tray resisting air from departing from below the floating plant propagation tray during a non-parallel position relative to the body of fluid;

FIG. 52 is a sectional view along line 52-52 in FIG. 49 illustrating the floating plant propagation tray having a buoyant equilibrium condition within the body of fluid;

FIG. 53 is a view similar to FIG. 52 illustrating the floating plant propagation tray resisting air from departing from below the floating plant propagation tray during a non-parallel position relative to the body of fluid;

FIG. 54 is a view similar to FIG. 10 illustrating the level initial contact between the tray and the water;

FIG. 55 is a view similar to FIG. 54 illustrating the displacement of the tray within the water,

FIG. 56 is a view similar to FIG. 55 illustrating the further displacement of the tray within the water;

FIG. 57 is a view similar to FIG. 56 illustrating the equilibrium or buoyant position of the tray relative to the water;

FIG. 58 is a view similar to FIG. 54 illustrating the non-level initial contact between the tray and the water;

FIG. 59 is an enlarged left portion of FIG. 58;

FIG. 60 is an enlarged right portion of FIG. 58;

FIG. 61 is the tray of FIG. 58 illustrating the displacement of the tray within the water and leveling of the tray related to the water;

FIG. 62 is a view similar to FIG. 58 illustrating different amount of air in each chamber below the tray and resulting in an initial non-level orientation between the tray and water;

FIG. 63 is an enlarged left portion of FIG. 62;

FIG. 64 is an enlarged right portion of FIG. 62;

FIG. 65 is the tray of FIG. 62 illustrating the displacement of the tray within the water and leveling of the tray related to the water;

FIG. 66 is a view similar to FIG. 62 illustrating air escaping from each chamber below the tray and resulting in a non-level orientation between the tray and water;

FIG. 67 is the tray of FIG. 66 illustrating the displacement of the tray within the water and leveling of the tray related to the water;

FIG. 68 is an enlarged portion of FIGS. 10, 12, 23, 25 and 30 illustrating a second floating plant propagation tray positioned adjacent;

FIG. 69 is a similar view to FIG. 68 illustrating an ascending water volume entering the soil cell chamber to dislodge the plurality of seeds and/or the plurality of seedlings;

FIG. 70 is an enlarged view of a portion of FIGS. 50, 52 and 57 illustrating a second floating plant propagation tray positioned adjacent; and

FIG. 71 is a similar view to FIG. 68 illustrating the ascending water volume channeled within a first J shape channel and a second J shape channel for producing a first horizontal water output and a second horizontal water output respectively.

Similar reference characters refer to similar parts throughout the several Figures of the drawings.

### DETAILED DISCUSSION

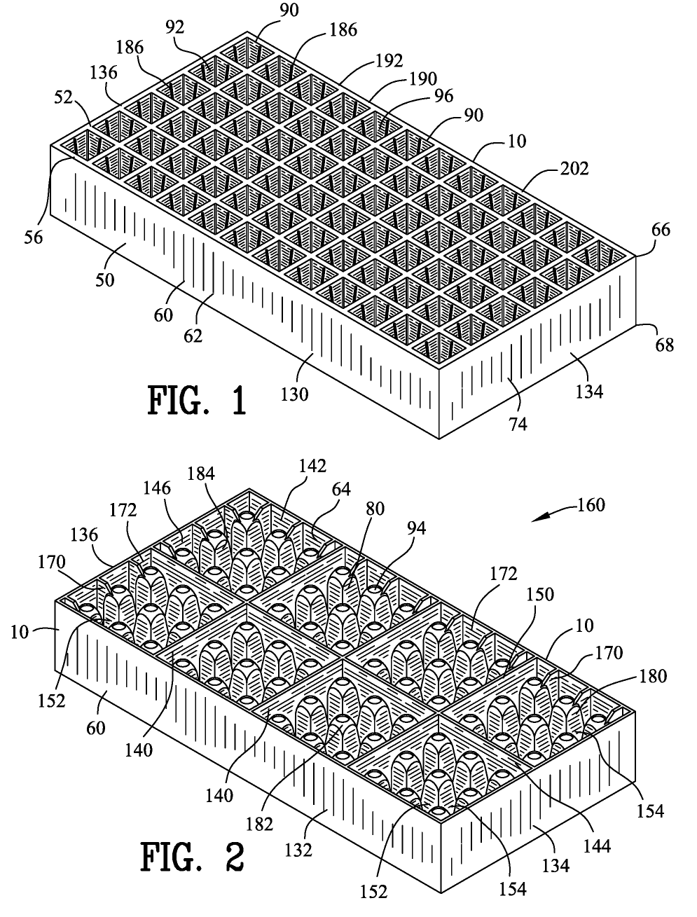

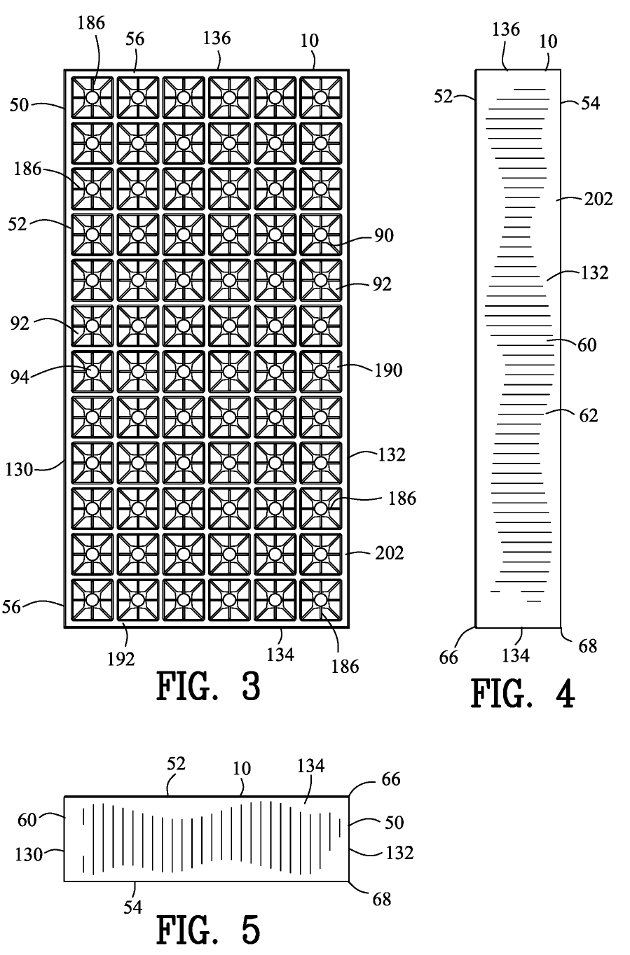

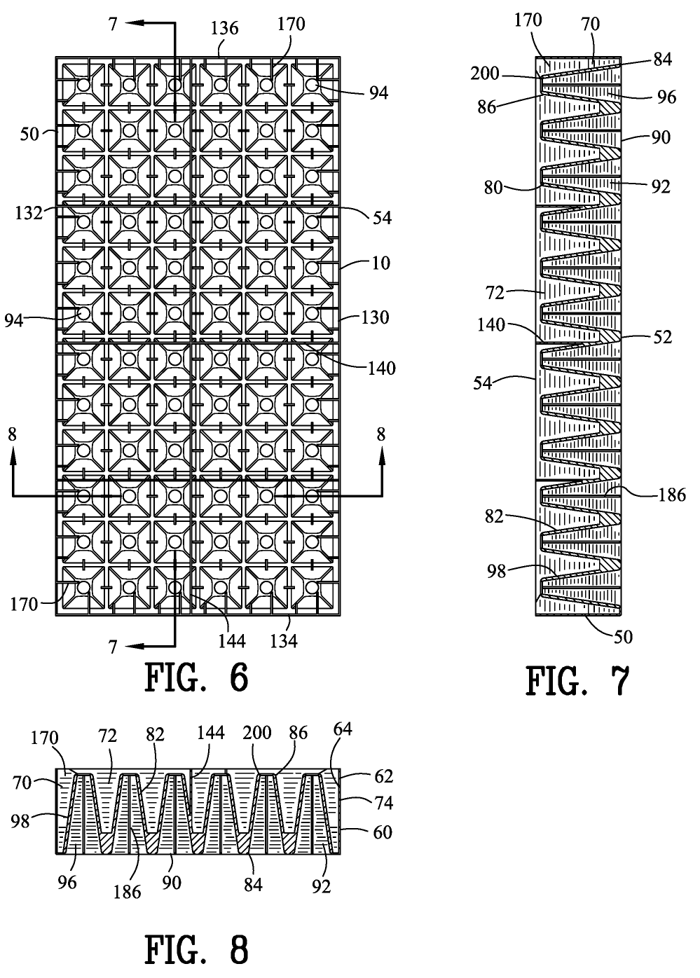

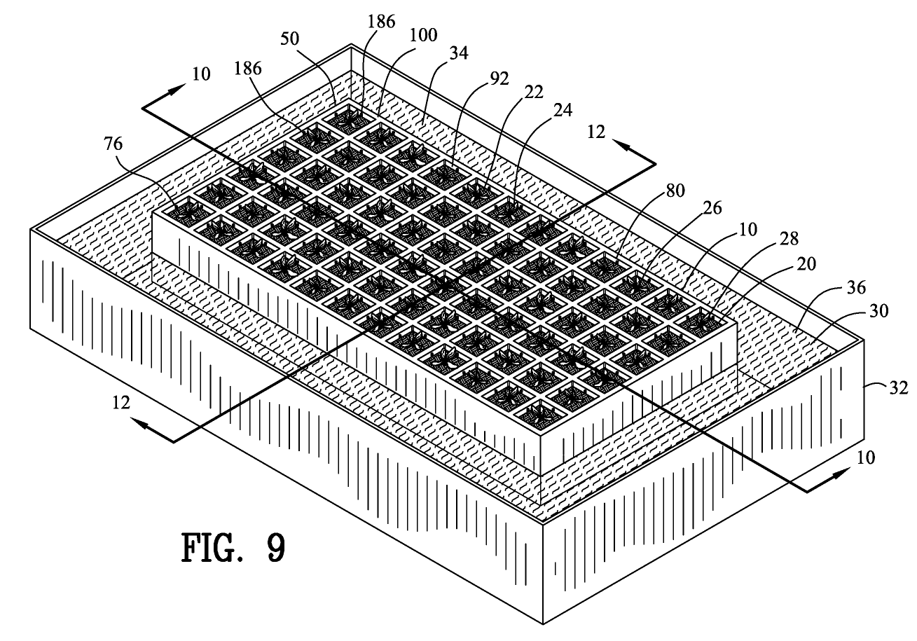

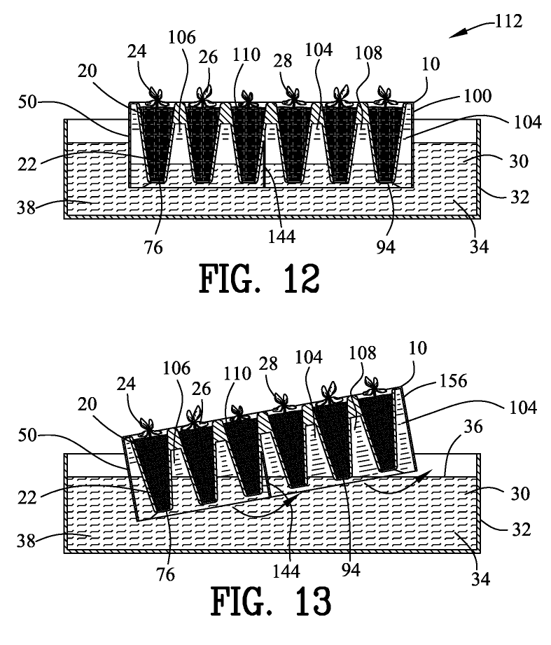

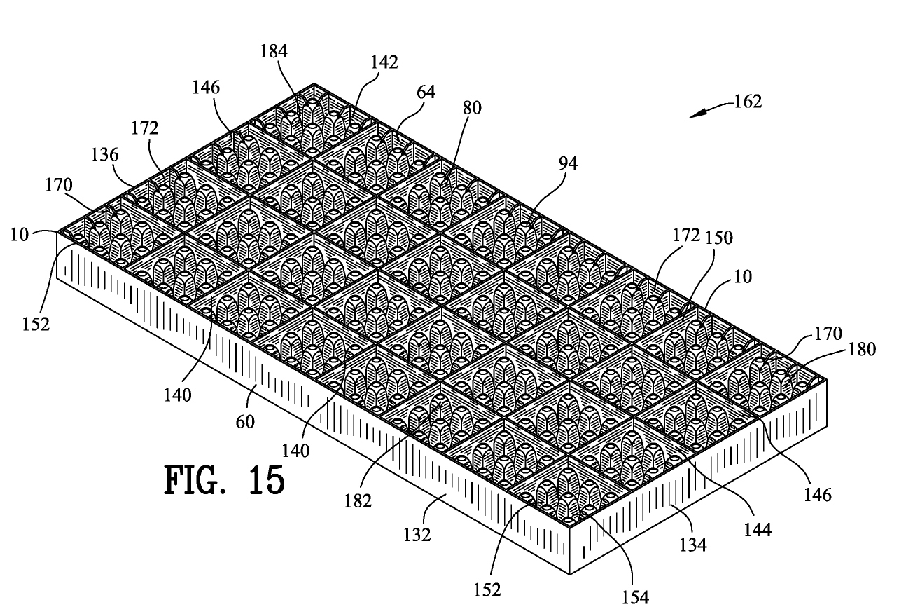

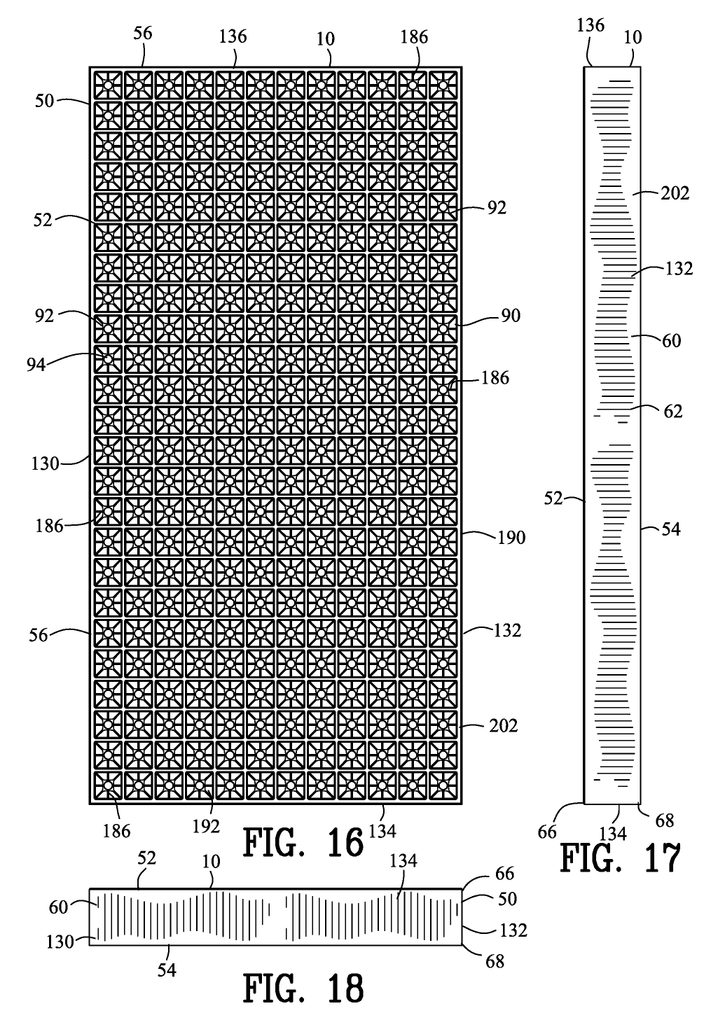

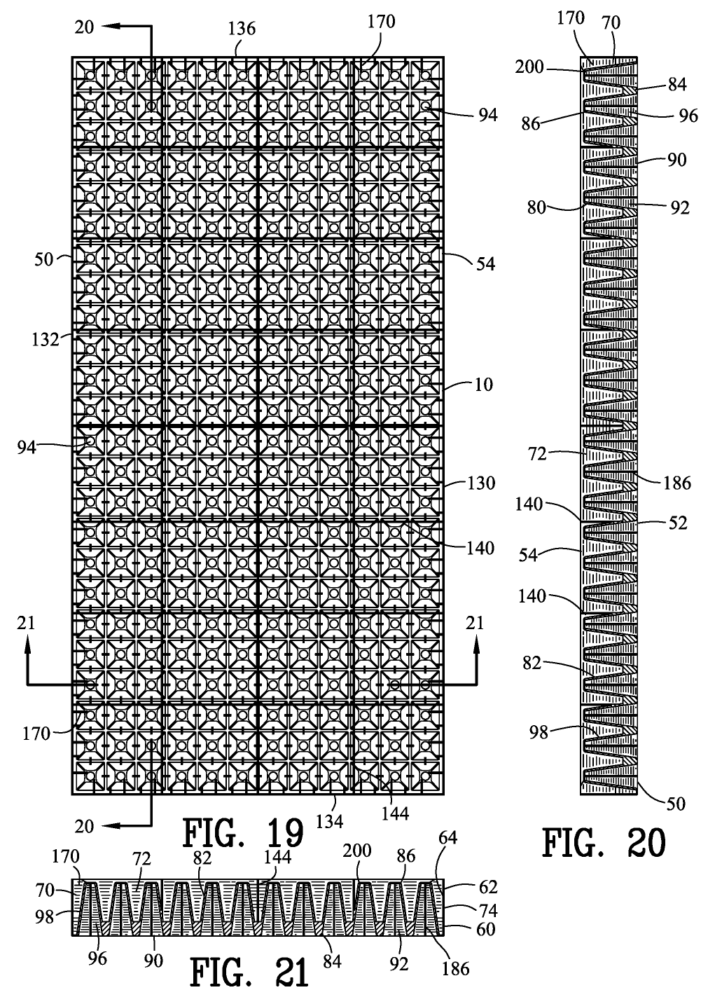

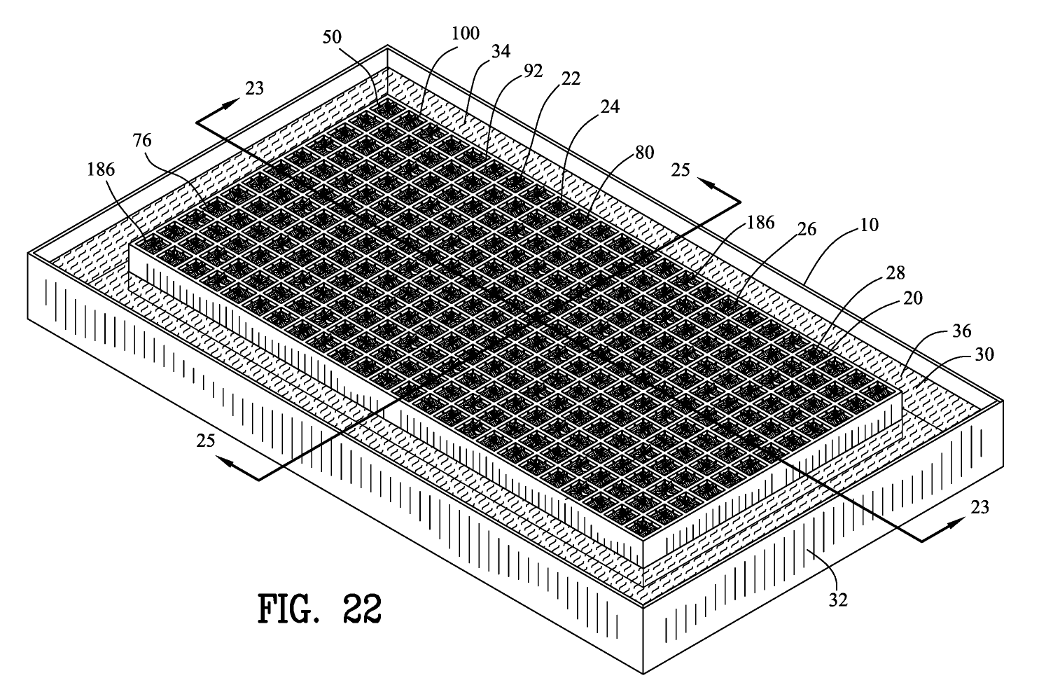

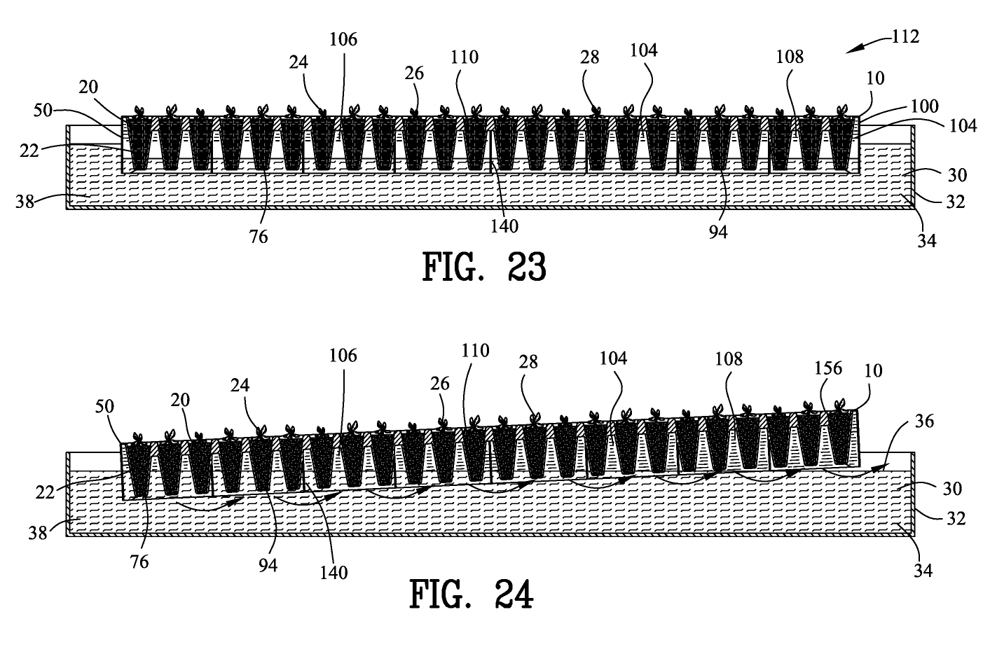

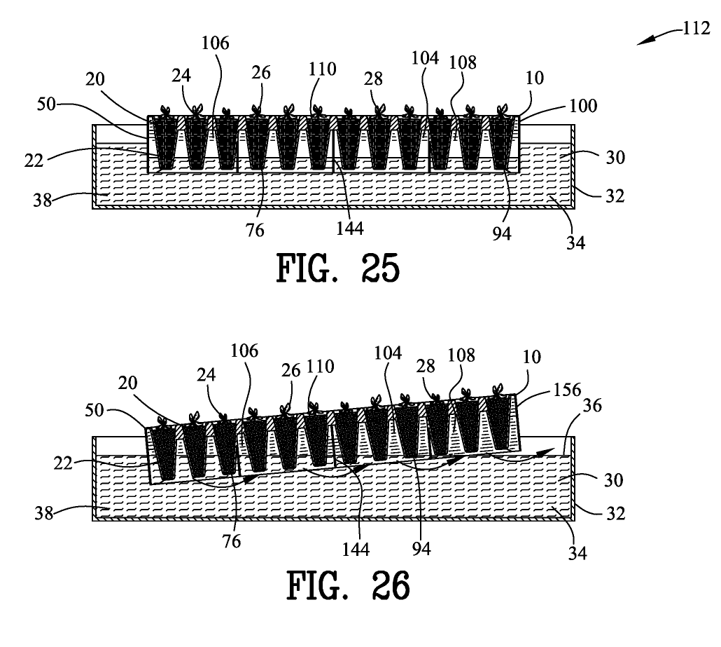

FIGS. 1-26 illustrate a floating plant propagation tray 10 for supporting soil 20, a plurality of seeds 22 and/or a plurality of seedlings 24. FIGS. 9-13 and FIGS. 22-26, illustrate the plurality of seedlings 24 including tobacco seedlings 26, however the plurality of seedlings 24 may include when any other type of plant propagule 28 from a seed.

The floating plant propagation tray 10 is preferably positioned within a body of fluid 30. The body of fluid 30 may include but not limited to an agricultural water tank 32, natural pond 34 or other bodies of water. The body of fluid to 30 includes a liquid surface 36 and a liquid depth 38. As shown in FIGS. 9-13 and 22-26, the floating plant propagation tray 10 is supported by the body of fluid 30.

The floating plant propagation tray 10 comprises a tray plate 50 including an upper surface 52, a lower surface 54 and a peripheral edge 56. A tray wall 60 includes an exterior surface 62, an interior surface 64, a proximal edge 66 and a distal edge 68. The proximal edge 66 of the tray wall 60 is coupled to the peripheral edge 56 of the tray plate 50. The tray plate 50 and the tray wall 60 define a tray chamber 70.

A plurality of soil cells 80 include a tapering cross section 82 extending between a proximal end 84 and a distal end 86. The proximal end 84 of the plurality of soil cells 80 are coupled to the lower surface 54 of the tray plate 50 and define an upper soil cell aperture 90. The plurality of soil cells 80 define a soil cell chamber 92 for receiving the soil 20 and the plurality of seeds 22 and/or a plurality of seedlings 24 through the upper soil cell aperture 90. The distal end 86 of the plurality of soil cells 80 include a lower soil cell aperture 94 for inputting a portion of the body of fluid 30 into the soil cell chamber 92 and permitting the germinating of the seeds 22. As the plants 28 further mature, the roots may grow through the lower soil cell apertures 94 and into the body of fluid 30 below the tray 10.

The plurality of soil cells 80 extend within the tray chamber 70 for defining a tray volume 72 within the tray plate 50, the tray wall 60 and around the plurality of soil cells 80. The plurality of soil cell chambers 92 define a cell volume 96. As shown in FIGS. 9-13 and 22-26, the cell volume 96 and the tray volume 72 define a buoyant equilibrium condition 100 for supporting the floating plant propagation tray 10, the soil 20 and the plurality of seeds 22 and/or a plurality of seedlings 24 within the body of fluid 30.

The cell volume may have a range between 2500 to 9000 cubic centimeters 102. The tray wall 60 and the plurality of soil cells 80 displace the body of fluid 30 and define a trapped air volume 104 within the tray plate 50, a portion of the tray wall 106 and around a portion of the plurality of soil cells 108. The trapped air volume 104 may have a range between 2500 to 15,000 cubic centimeters 110. Stated alternatively the cell volume 96 and the trapped air volume 104 have a ratio between 1 to 1, 1 to 2, 1 to 3, 1 to 4, 1 to 5 or 1 to 6, 112.

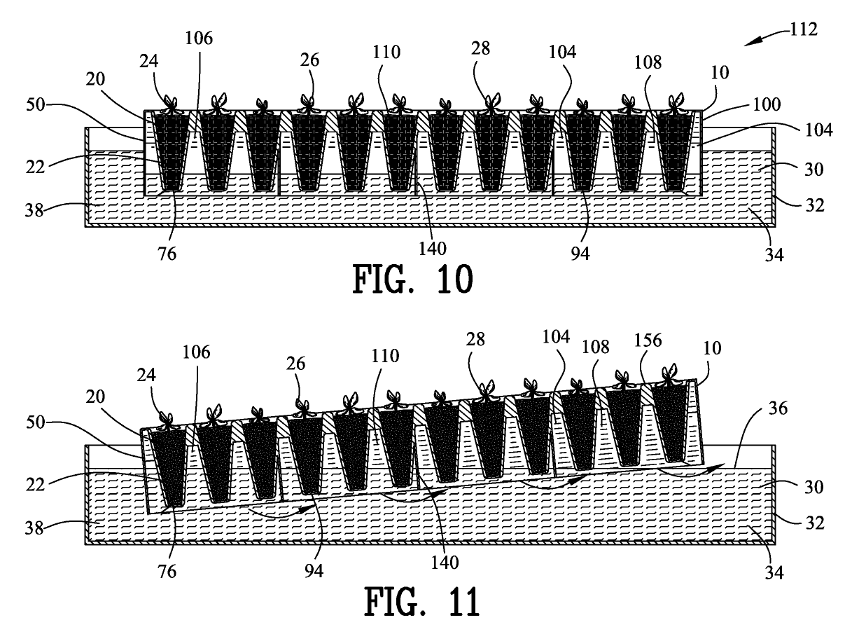

As best shown in FIGS. 10, 12, 23 and 25, upon the insertion of the floating plant propagation tray 10 within the body of fluid 30, the tray wall 60 displacing the body of fluid 30 and a portion of the air beneath the floating plant propagation tray 10 traverses the lower soil cell aperture 94 and the soil 20. The soil 20 acts as a filter 76 to slow the flow of air from the tray chamber 70. Upon the plurality of soil cells 80 traversing the liquid surface 36, the flow of air from the tray chamber 70 through the lower soil cell aperture 94 terminates. Thereafter, the plurality of soil cells 80 displace the body of fluid 30 and compresses the trapped air volume 104 within the tray chamber 70.

As the plurality of soil cells 80 displace the body of fluid 30, the distal end 86 of the plurality of soil cells 80 are submerged beneath the liquid surface 36 and thereafter be a portion of the body of fluid 30 traverses the lower soil cell aperture 94 and into the soil 20. As the soil 20 absorbs the portion of the body of fluid 30, the floating plant propagation tray 10 becomes more heavy and further compresses the trapped air volume 104 within the tray chamber 70. In addition, as the plurality of seedlings 26 grow, the floating plant propagation tray 10 becomes even more heavy and further compresses the trapped air volume 104 within the tray chamber 70. The compression of the trapped air volume 104 maintains the buoyant equilibrium condition 100 and prevents the floating plant propagation tray 10 from sinking within the body of fluid 30. The depth of the floating plant propagation tray 10 relative to the body of fluid 30 provides an adequate moisture content within the soil 24 for maintaining a healthy plurality of seeds and/or plurality of seedlings 24.

The tray wall 60 includes a front side wall 130, a rear side wall 132, a primary side wall 134 and a secondary side wall 136. A plurality of primary bulkheads 140 extend between the front side wall 130 and the rear side wall 132 for defining a plurality of primary air chambers 142 within the tray chamber 70. A plurality of secondary bulkheads 144 extend between the primary side wall 134 and the secondary side wall 136 for defining a plurality of secondary air chambers 146 within the tray chamber 70.

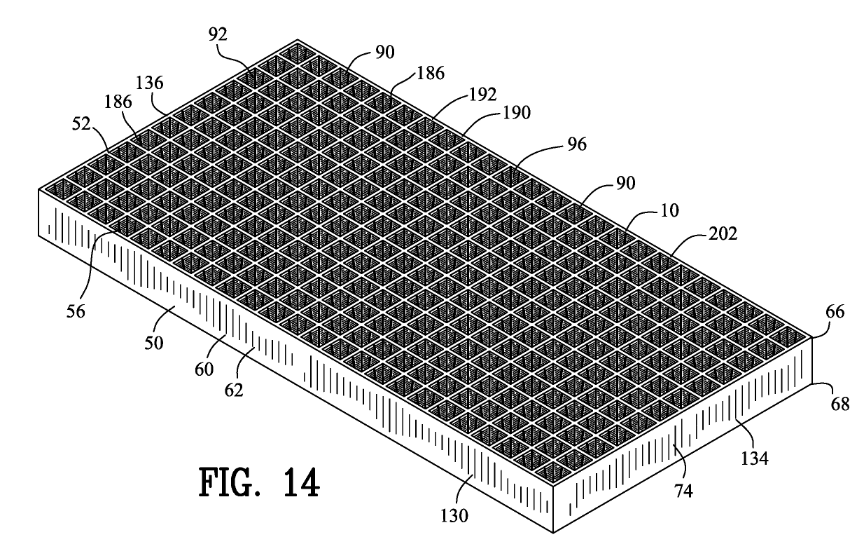

The plurality of primary bulkheads 140 and the plurality of secondary bulkheads 144 define a grid of air chambers 150 including a plurality of individual row air chambers 152 and a plurality of individual column air chambers 154. As shown in FIGS. 11, 13, 24 and 26, tray wall 60 and the grid of air chambers 150 resist air from departing from the tray chamber 70 upon the tray plate 50 have a non-parallel position 156 relative to the liquid surface 36 of the body of fluid 30. As shown in FIGS. 1-13, the grid of air chamber 150 may include 8 air chambers 160. In addition FIGS. 1-13 illustrate the tray plate 50 having 72 soil cells. Alternatively, as shown in FIGS. 14-26, the grid of air chamber 150 may include 84 air chambers 162. In addition FIGS. 14-26 illustrate the tray plate 50 having 288 soil cells 80. It should be understood that the floating plant propagation tray 10 may include other numbers of grid air chambers 150 and or other numbers of soil cells 80. For example, the number of soil cells 80 within the tray plate 50 may have a range between 8 and 800 cells.

By maintaining the trapped air volume 104 within the tray chamber 70 the floating plant propagation tray 10 is maintained in the buoyant equilibrium condition 100 and prevents the floating plant propagation tray 10 from sinking below the liquid surface 36 of the body of fluid 30.

FIGS. 2, 6-8, 10-13, 15, 19-21 and 23-26 illustrate a cell bulkhead 170 extending between the interior surface 64 of the tray wall 60 and each plurality of soil cells 80 adjacent to the tray wall 60. The cell bulkheads 170 define a plurality of peripheral chambers 172. The plurality of peripheral chambers 172 further resist air from departing from the tray chamber 70 upon the tray plate 50 having a non-parallel position 156 relative to the liquid surface 36 of the body of fluid 30.

The plurality of soil cells 80 may include a generally square tapering cross section portion 180 and/or a generally conical tapering cross section portion 182. The generally square tapering cross section portion 180 extends from the proximal end 84 to an adjacent point 184 of the distal end 86 of the plurality of soil cells 80. The generally conical tapering cross section portion 182 extends from the distal end 86 to the adjacent point 184 of the distal end 86 of the plurality of soil cells 80. The generally conical tapering cross section portion 182 can reduce the cell volume 96 and decrease the weight of the soil of 20 for increasing the buoyancy of the floating plant propagation tray 10. Alternatively, the plurality of soil cells 80 may include a round, hexagonal or other cross sections.

Preferably, the tray plate 50, the tray wall 60, the plurality of soil cells 80, the plurality of primary bulkheads 140, the plurality of secondary bulkheads 144 and the plurality of cell bulkheads 170 are constructed from an integral one piece unit 190. The integral one piece unit 190 may include a density with a range between 0.8 grams/cubic centimeters and 1.0 grams/cubic centimeters. The integral one piece unit 190 may be constructed from a thermoplastic polymer 192 including but not limited to a polypropylene, polyethylene, or polystyrene (non-expanded) and from an injection molding process or a thermoforming process.

As a benefit, the thermoplastic polymer 192 may be constructed from recycled material as a benefit to the environment. Upon termination of the useful life of the floating plant propagation tray 10, the floating plant propagation tray 10 may be recycled as an additional benefit to the environment. Furthermore, the thermoplastic polymer 192 may be easily sterilized. Furthermore, the thermoplastic polymer 192 may include a black pigment 202 such that the floating plant propagation tray 10 may absorb the natural sunlight and increase the temperature of the soil 20, plurality of seeds 22 and/or the plurality of seedlings 26.

As best shown in FIGS. 7, 8, 10-13, 20, 21 and 23-26, the tray wall 60 has a wall height 74. The plurality of soil cells 80 have a cell height 98. The cell height 98 includes a less than dimension 200 to the wall height 74 for increasing the tray volume 72 and reducing the plurality of soil cells 80 displacement within the body of fluid 30. The less than dimension 200 may have a range between 0 mm and 25 mm.

FIGS. 9, 10, 12, 22, 23, 25 and 30 illustrate the soil 20 absorbing the water 30 and the tray 10 gains additional weight and thus air is further compressed within the tray chamber 70. As the plant grows, the tray 10 gains additional weight and thus air is further compressed within the tray chamber 70. The displacement of the tray 10 within the water 30 is shown to be above the lower soil cell aperture 94. This condition would be only expected as a level when the plants 28 are fairly mature i.e. the plants 28 are larger. Conversely when the tray 10 is placed in the water 30 without any water 30 being taken up by the soil 20 and without any plant 28 being there to add weight, the tray 10 would be displacement less into the water 30.

FIGS. 11, 13, 24 and 26 illustrate the tray 10 that is placed on the water 30 in an extreme non-level orientation. Air would partially evacuate from the grid of air chambers 150 but would also be compressed within the grid of air chambers 150. The grid of air chambers 150 assist in maintaining an adequate volume of air within the gird of air chambers 150 for preventing the lower side of the tray 10 from being submerged under the water 30. The tray 10 will thereafter become level after air escapes differentially through the lower soil cell aperture 94 and soil 20 of the cell 80 from each individual chamber 150 leaving water at the same level in all chambers 150 as shown in FIGS. 34 and 40.

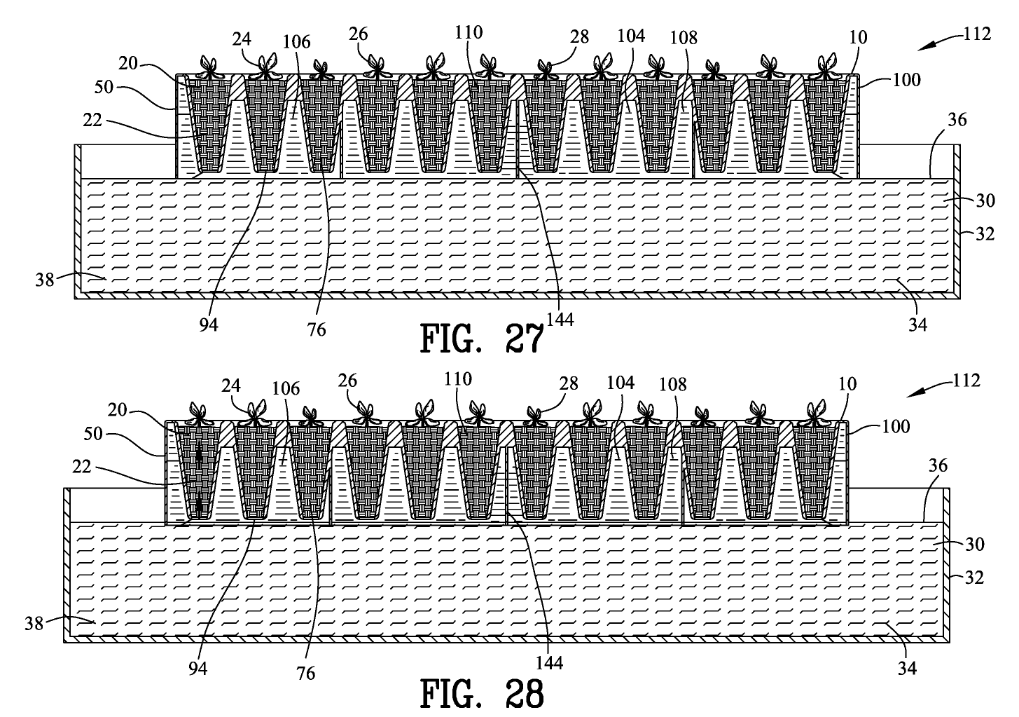

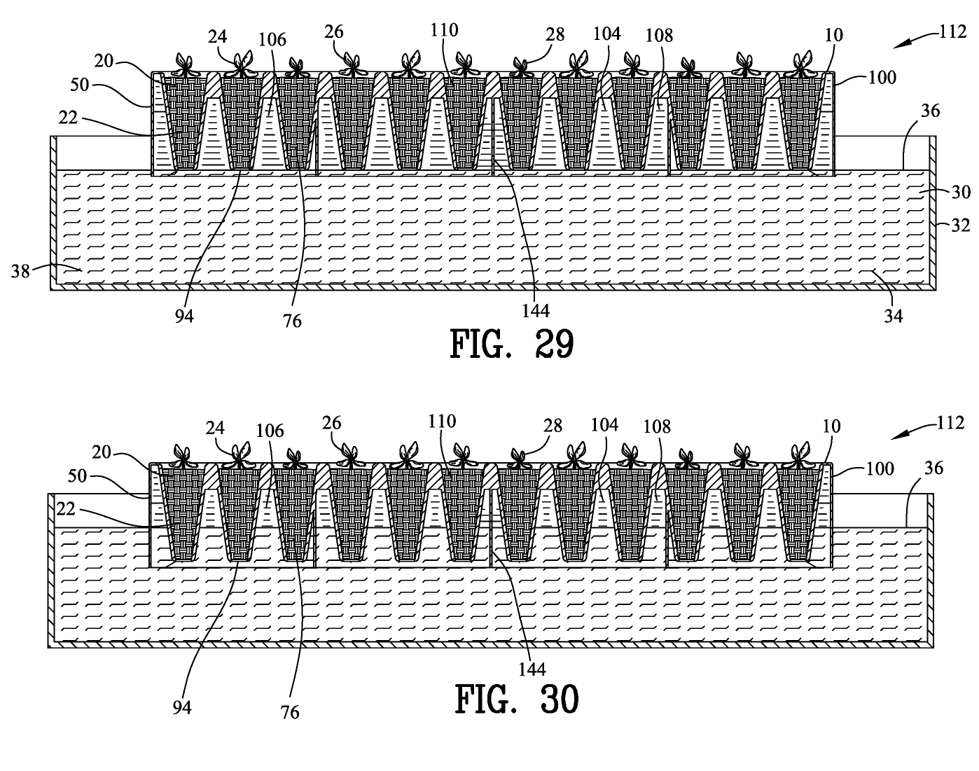

FIG. 27 illustrates the tray 10 that is placed level on the water 30. FIG. 28 illustrates the initial sinking of the tray 10 and the initial compression of the air within the tray chamber 70. Secondarily air escapes through the lower soil cell aperture 94 and soil 20. FIG. 29 illustrates a primary equilibrium with the water 30 contacting the lower soil cell aperture 94. FIG. 30 illustrates the soil 20 thereafter absorbing the water 30 and the tray 10 gains additional weight and thus air is further compressed within the tray chamber 70. As the plant grows, the tray 10 gains additional weight and thus air is further compressed within the tray chamber 70. The displacement of the tray 10 within the water 30 is shown to be above the lower soil cell aperture 94. This condition would be only expected as a level when the plants 28 are fairly mature i.e. the plants 28 are larger. Conversely when the tray 10 is placed in the water 30 without any water 30 being taken up by the soil 20 and without any plant 28 being there to add weight, the tray 10 would be displacement less into the water 30.

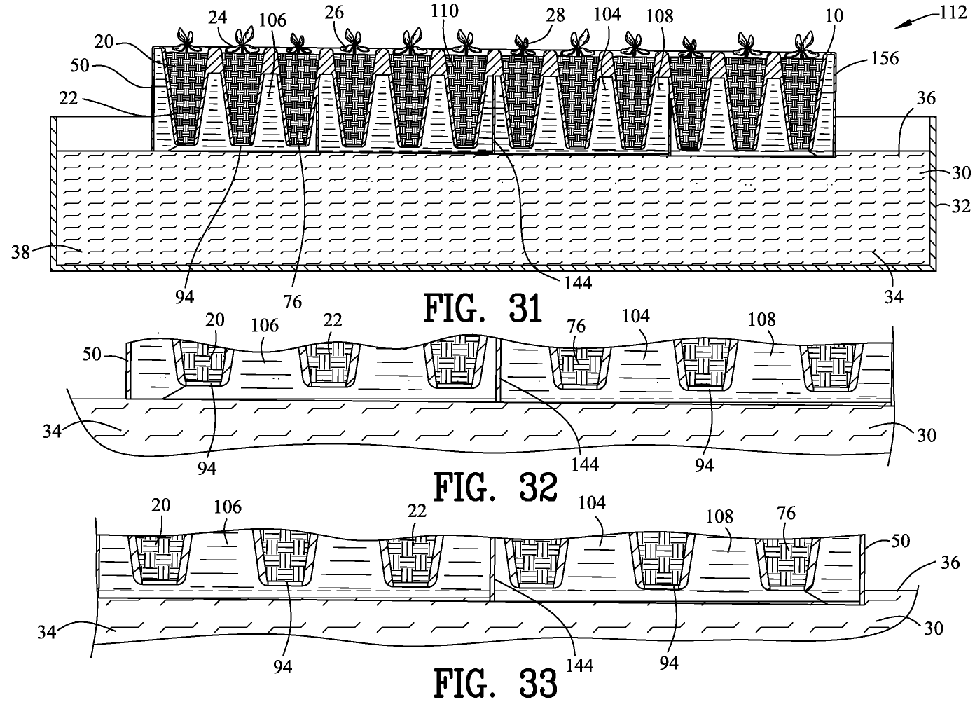

FIGS. 31-33 illustrate the tray 10 that is placed on the water 30 in a non-level orientation. The dashed line represents the water 30 line if the grid of air chambers 150 were not present. If the grid of air chambers 150 were not full depth dividing ribs the air in the lower most chamber would be greater than the upper most chamber and thus the tray would stay at an angle in the water. As shown in FIGS. 31-33 even when the tray 10 is placed on the water 30 in a non-level orientation each of the grid of air chambers 150 contains the equivalent volume of air and thus will retain a level orientation as shown in FIG. 34. More specifically, as shown in FIG. 34, once the tray 10 is released it will level itself out and results in the condition and process as shown in FIGS. 29 and 30.

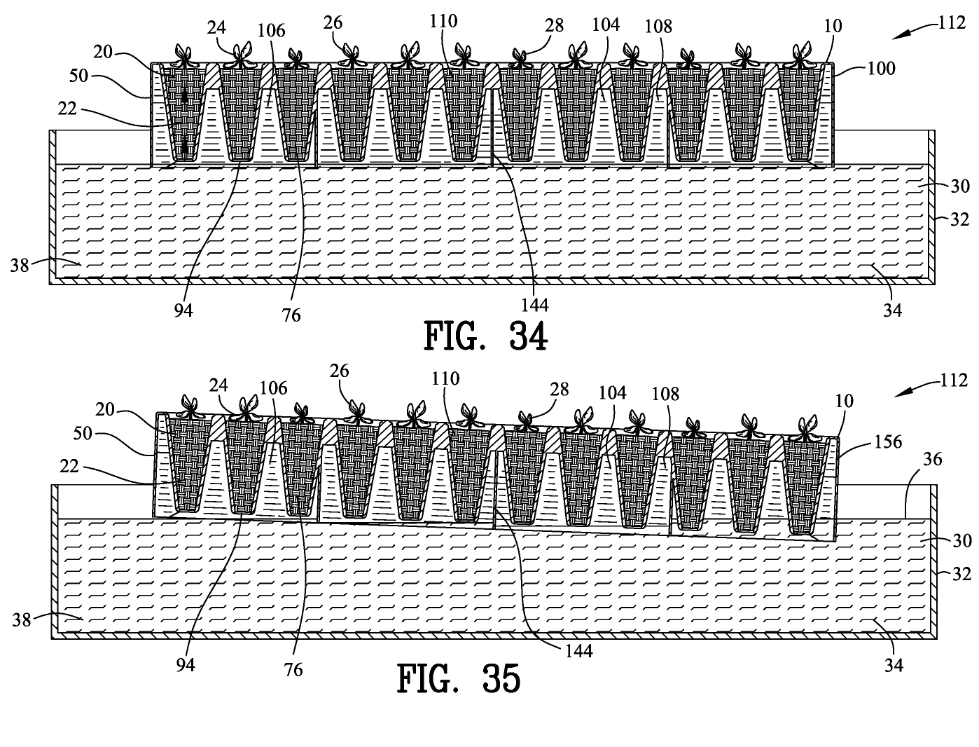

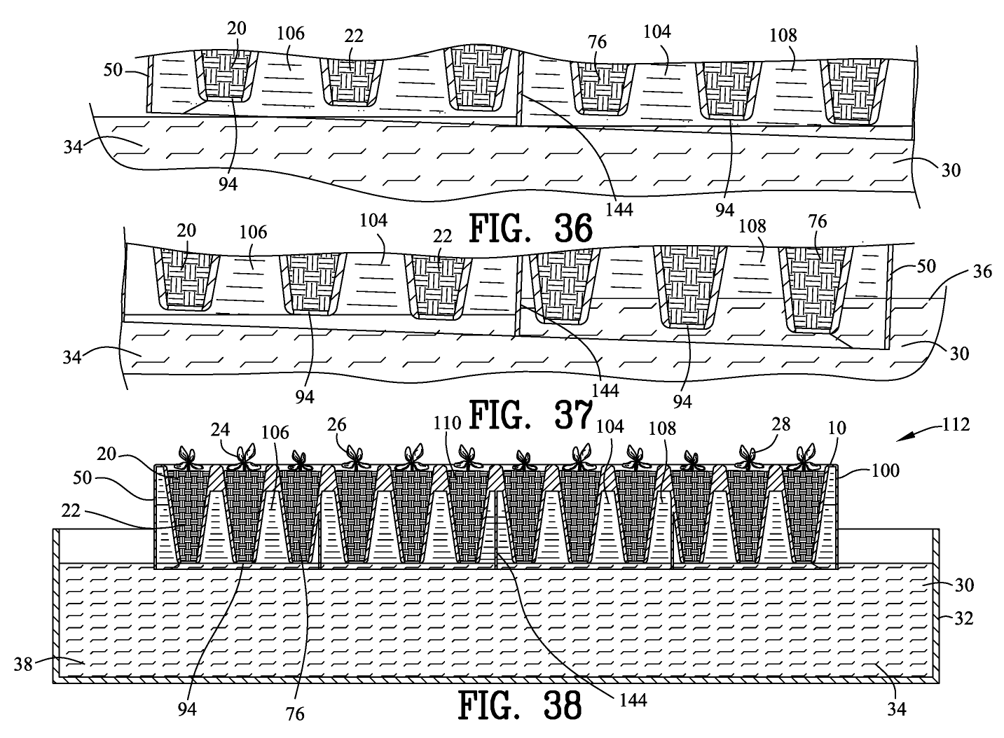

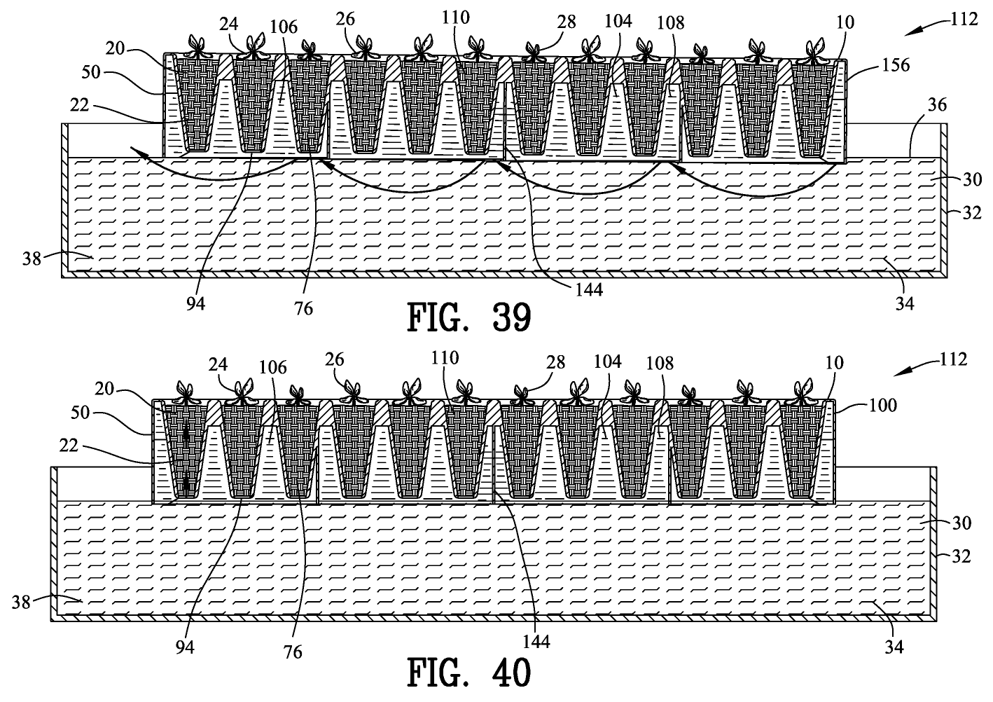

FIGS. 35-37 are similar to FIGS. 31-33 but differ in that the amount of air remaining in each grid of air chambers 150 is different which can happen under varying conditions. In this situation as long as the amount of air left in each grid of air chambers 150 is still below the base of the cell then although the tray 10 will initially sit at an angle in the water it will level itself out as air escapes differentially through the lower soil cell aperture 94 and soil 20 of the cell 80 from each individual chamber 150 leaving water at the same level in all chambers 150 as shown in FIG. 38. Once the tray 10 has level out as shown in FIG. 38, the tray 10 thereafter results in the condition and process as shown in FIGS. 29 and 30.

FIG. 39 is similar to FIGS. 35-37 but differ in that the air is purged out of the chambers 150 manually after the tray 10 is placed in the water which can happen due to rough handling etc. The tray 10 may be displaced into the water 10 by a descending force. The descending displacement of the tray 10 deeper into the water 30 may result in air passing out of the chambers 150. The passing of air from the chambers 150 is limited by the full depth structure of the bulkheads 140, 142, 144 and 146 and the tray wall 60. In other words, the purpose of the full depth structure of the bulkheads 140, 142, 144 and 146 and the tray wall 60 is to stop this air escaping when the tray 10 is placed in the water in a non-horizontal fashion. The use of the individual chambers 150 reduces the loss of air when the tray 10 is placed into the water in a non-horizontal fashion.

Another benefit of the individual buoyancy chambers 150 is that if one buoyancy chamber 150 is pierced, for example if a hole is made in the tray 10 in the tray plate 50 then air will only be lost out of this individual buoyancy chamber 150 and thus the tray 10 will not sink i.e. will not lose all of its air and therefore buoyancy. Furthermore, the extra depth outside perimeter wall 60 on the tray 10 prevents the loss of air once the tray 10 is placed in the water if the tray 10 is rocked about substantially which is often done when moving the trays 10 into position after they are lowered into the water 30.

The extra depth outside perimeter wall 60 may be between 0 mm and 25 mm to contain more air when placed in the water 30 in non-horizontal fashion but also to contain more air in total when placed in the water on a horizontal fashion. The extra depth outside perimeter wall 60 traps proportionally more and more air which is then compressed as the tray 10 sinks into the water 30 and in particular after the soil 20 takes up moisture and the plant grows. This extra air volume therefore has a benefit in helping to stop the tray 10 sinking too far into the water 30. More specifically with the depth outside perimeter wall 60 it is possible that there are different levels of water 30 in air chambers 150 underneath the tray 10 when it is introduced into the water 30 and as long as these varying water levels are lower in the tray 10 than the lower soil cell aperture 94 then as air filters out through the lower soil cell aperture 94 and soil 20 and is replaced by water 30 then all of the water levels within the buoyancy chamber 150 will become the same i.e. the depth of the lower soil cell aperture 94. As more weight is added to the tray 10 by the soil 20 taking on water 30 and the plant 28 growing, the tray 10 will go deeper and deeper into the water 30 so that the lower soil cell aperture 94 is below the water level.

The distribution of buoyancy chambers 150 in the tray 10 may be square in order to create stability and level floating of the tray 10 both across and along the tray 10. More specifically, the full depth ribs are distributed fairly uniformly in both directions. Furthermore, the buoyancy chambers 150 have a symmetrical distribution and are evenly distributed over the tray 10 in order to create level flotation.

Once the descending force is removed from the tray 10, the soil 20 thereafter absorbs the water 30 and the tray 10 gains additional weight and thus air is further compressed with the tray chamber 70. As the plant grows, the tray 10 gains additional weight and thus air is further compressed with the tray chamber 70. More specifically, as shown in FIG. 40, the tray 10 levels itself out and results in the condition and process as shown in FIGS. 29 and 30. The final depth of buoyancy of the tray 10 relative to the water 30, as shown in FIGS. 9, 10, 12, 22, 23, 25 and 30 is beneficial in that first the final depth of buoyancy is not great enough to sink the tray 10 and second the final depth of buoyancy is not great enough to water log the soil 20 within the cells 80. If the soil 20 within the cells 80 were to become water logged, the plants 28 could become unhealthy and possibly the cause of death for the plants 28. The final depth of buoyancy permits the correct displacement of the tray 10 within the water 30 to providing the correct soil moisture within the soil 20 for promoting healthy plant growth.

The plurality of soil cells 80 may include one or more vertical root training ribs 186 extending into the soil cell chambers for promoting the vertical growth of the plurality of seedlings 24. The vertical root training ribs 186 may be 1 to 5 mm in height and 0.2 to 2 mm in width. The vertical root training ribs 186 may be positioned on various walls of the cell 80. Preferably, the vertical root training ribs 186 are positioned in the centre line of each flat wall and are designed to stop circling roots and redirect them down the cell 80 to the lower soil cell aperture 94. The vertical root training ribs 186 also aids drainage and aeration of the cell 80. The vertical root training ribs 186 may extends from the upper soil cell aperture 90 or adjacent to the upper soil cell aperture 90. The height of the vertical root training ribs 186 may taper from a maximum height at the upper soil cell aperture 90 to a zero height at the lower soil cell aperture 94 so there is no sharp edges or ends. Alternatively, the height of the vertical root training ribs 186 may remain constant from the upper soil cell aperture 90 to the lower soil cell aperture 94 such that the vertical root training ribs 186 are positioned within the upper soil cell aperture 90 and the lower soil cell aperture 94.

In addition, the vertical root training ribs 186 may extend across the lower soil cell aperture 94 and from one side of the cell 80 all the way across to the other side and join up with its adjoining ribs 186 to create a cross across the lower soil cell aperture 94.

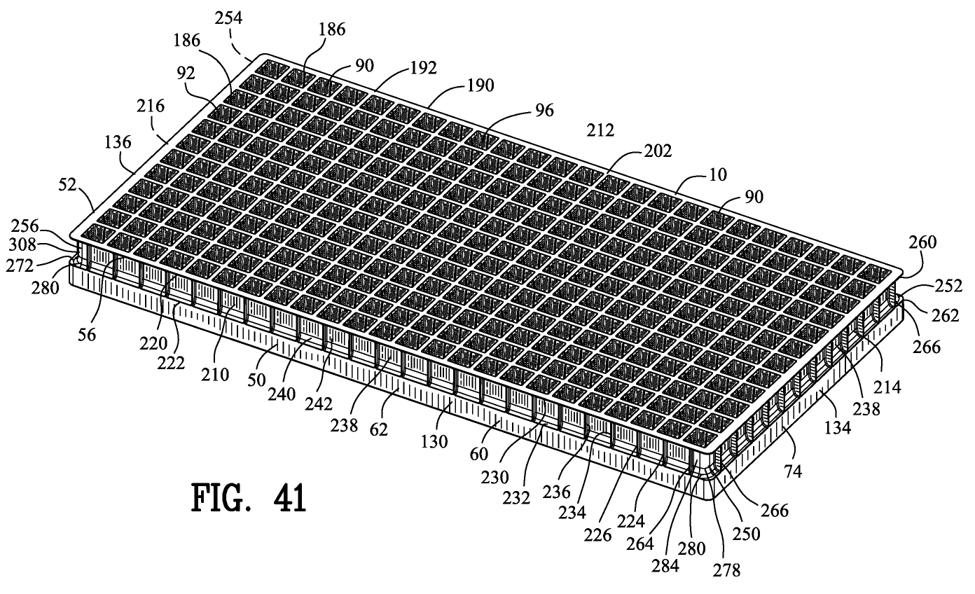

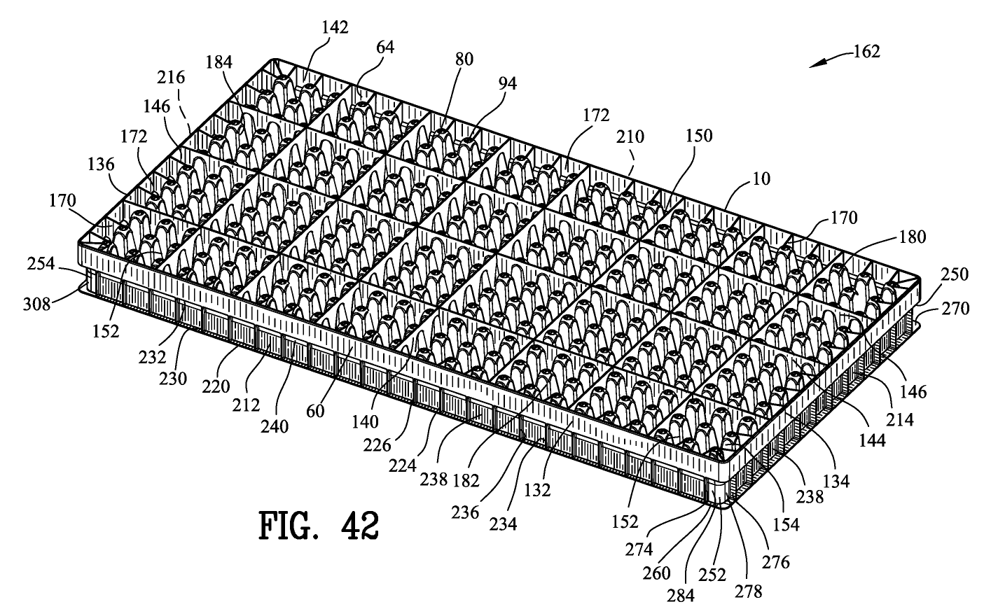

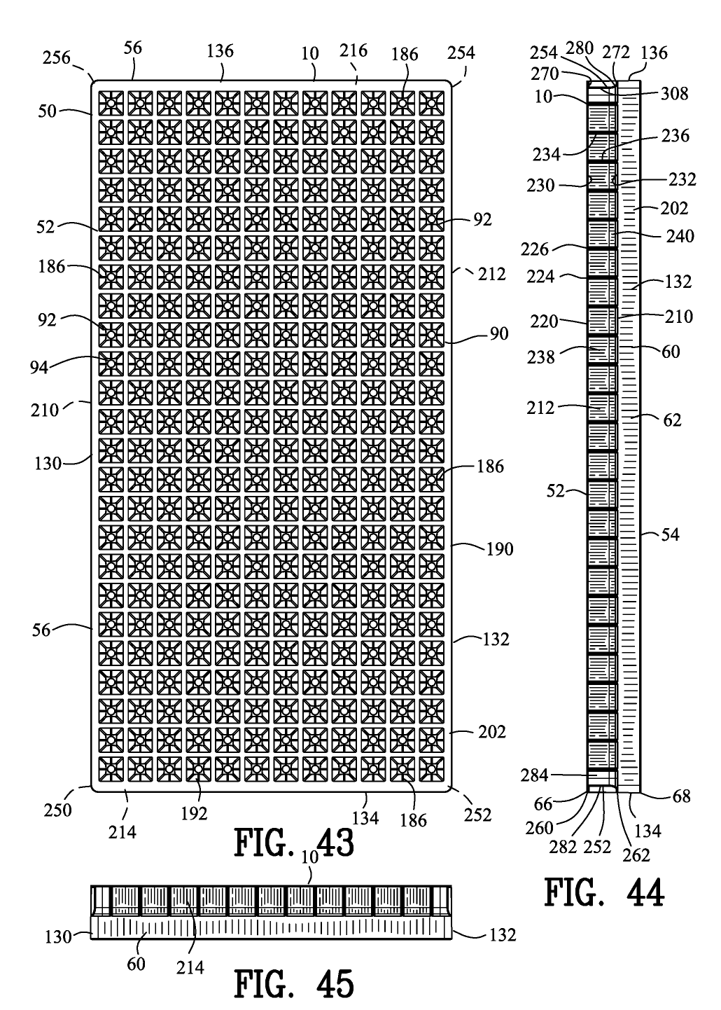

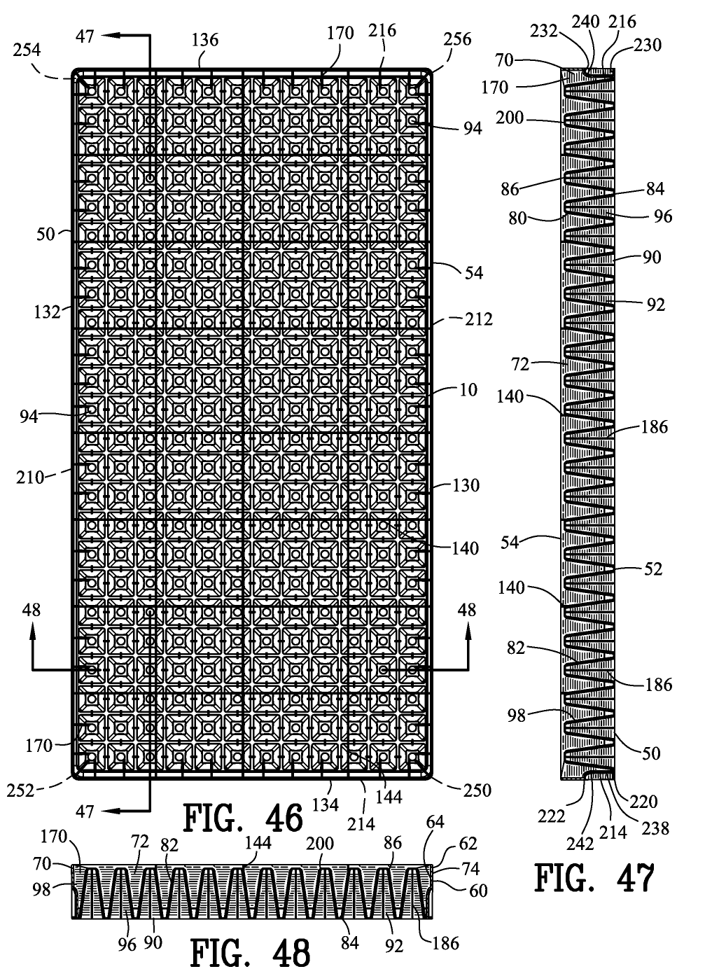

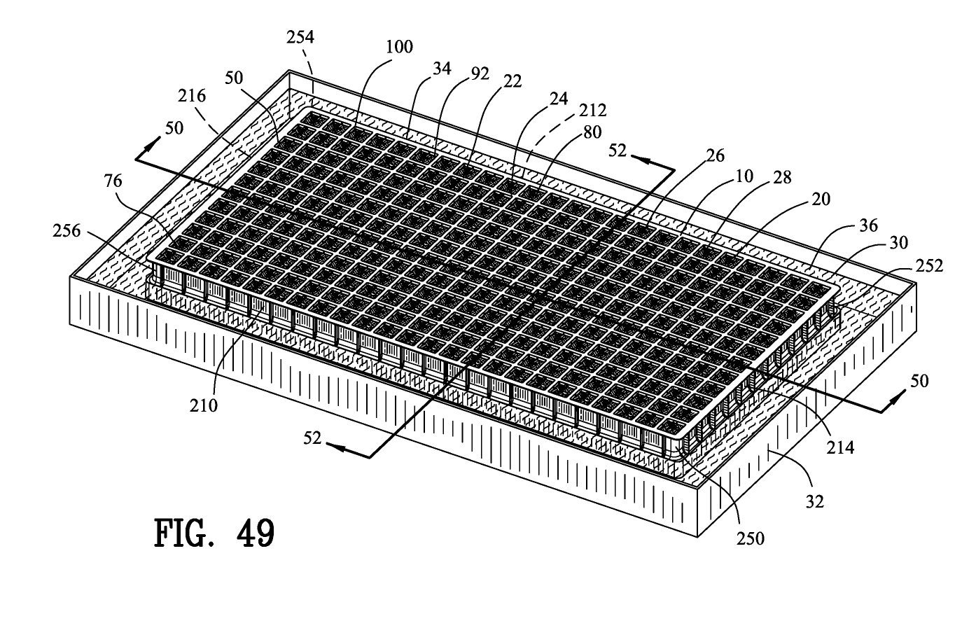

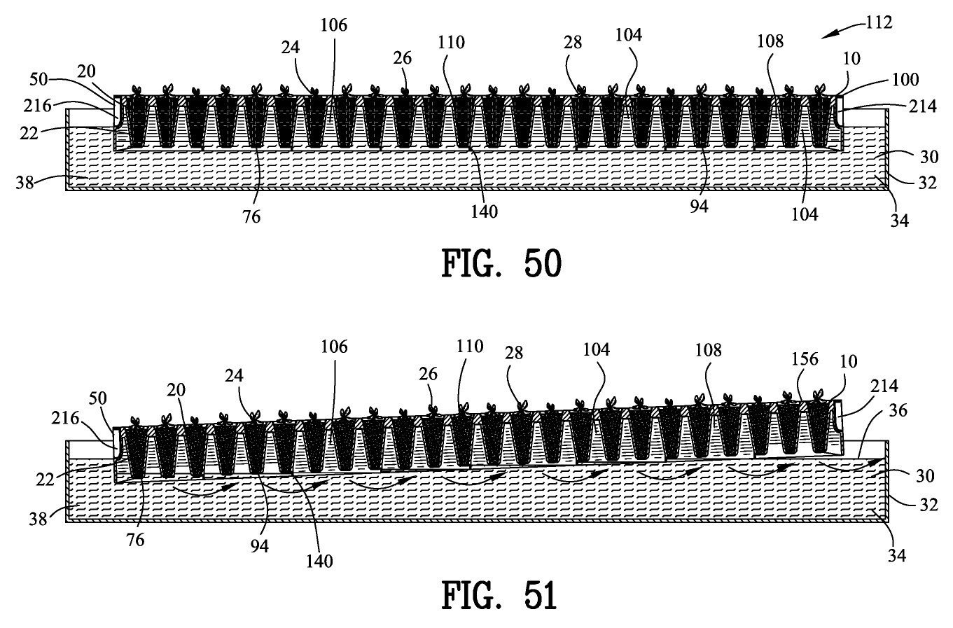

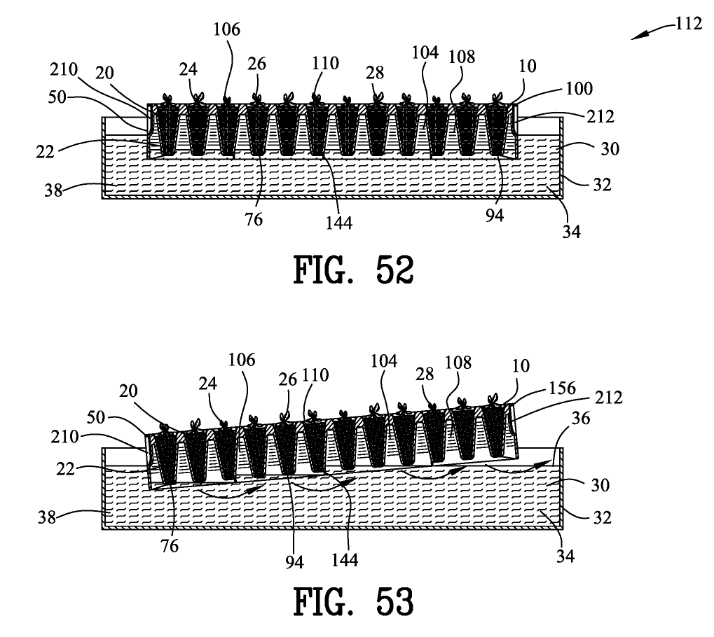

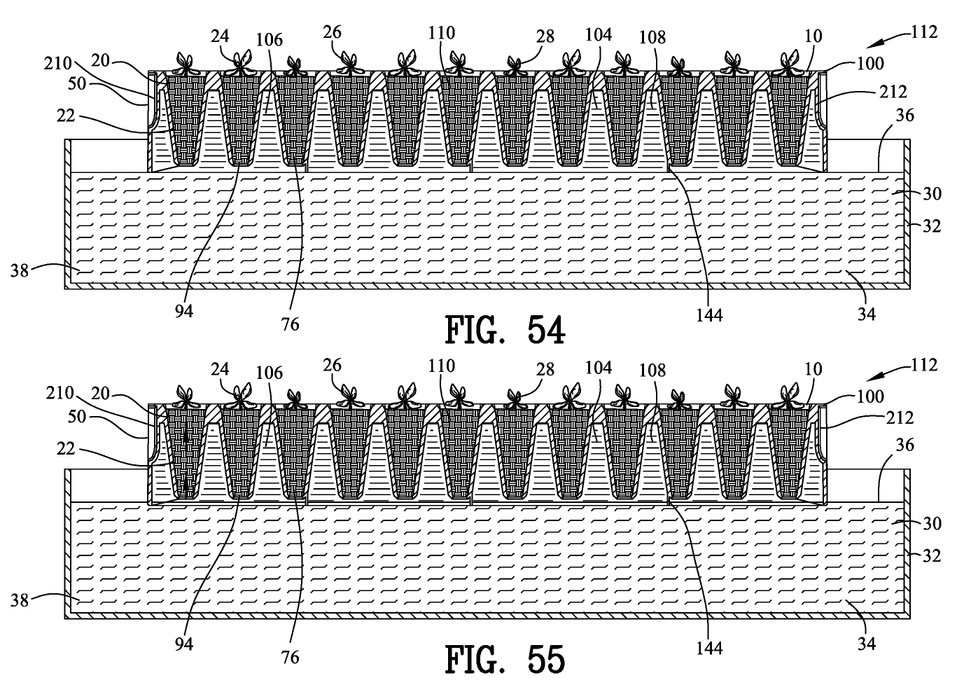

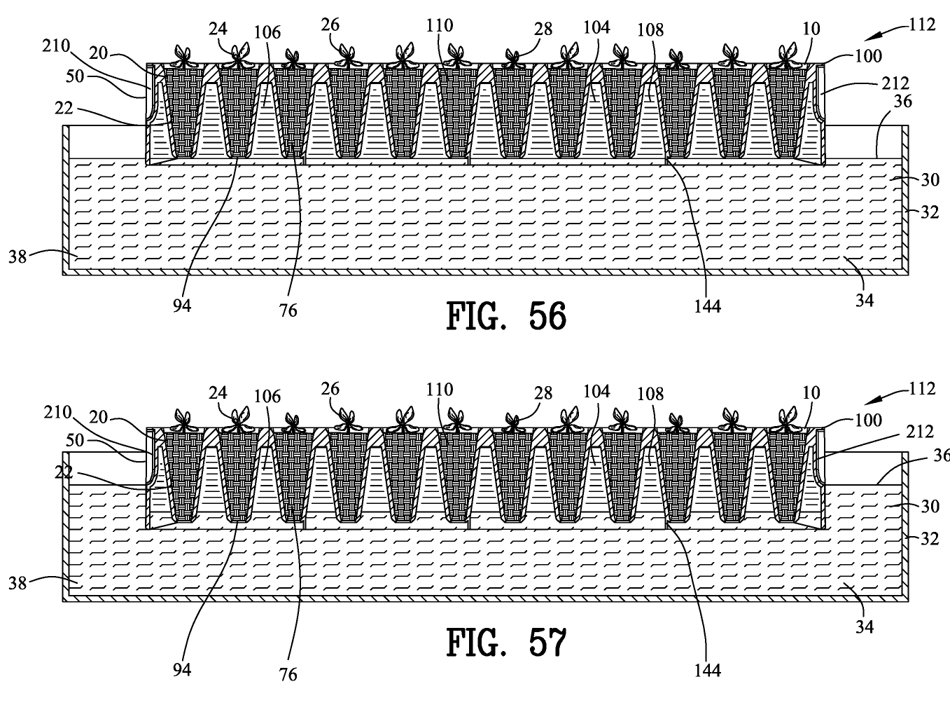

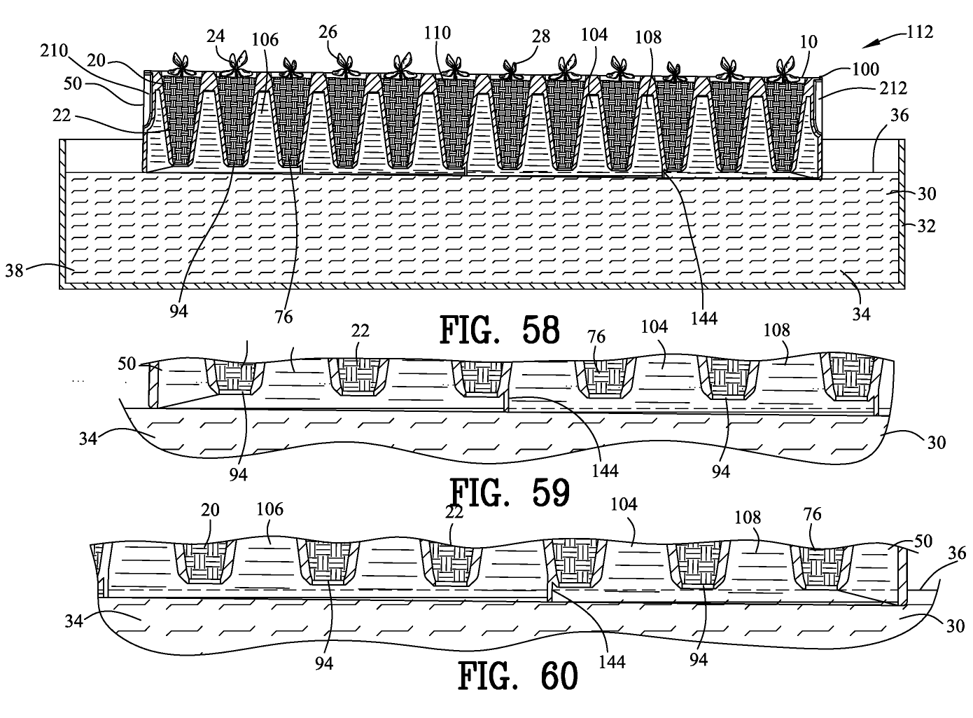

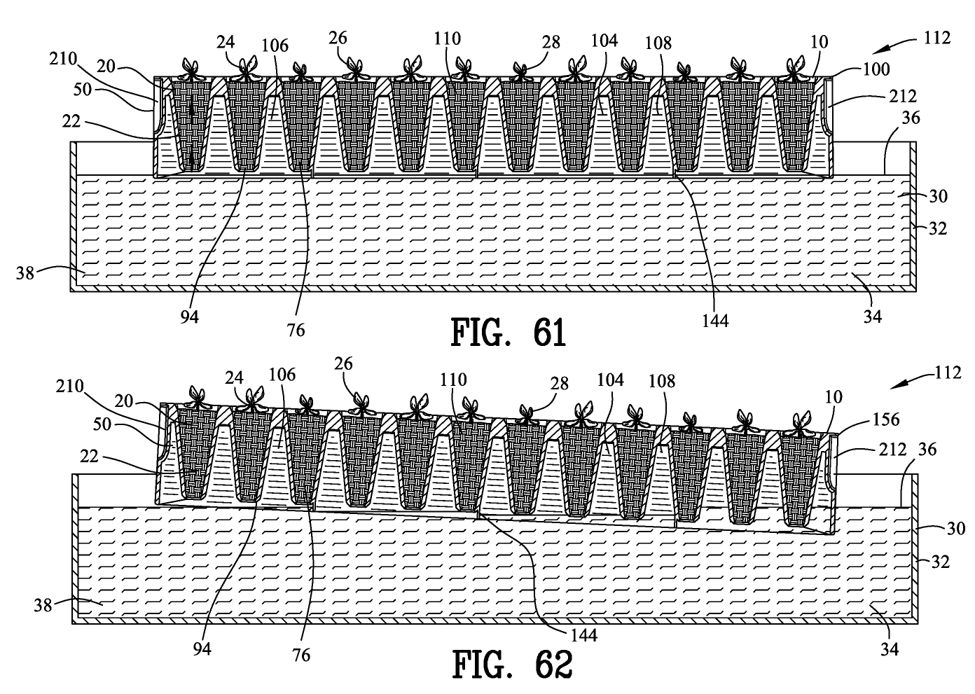

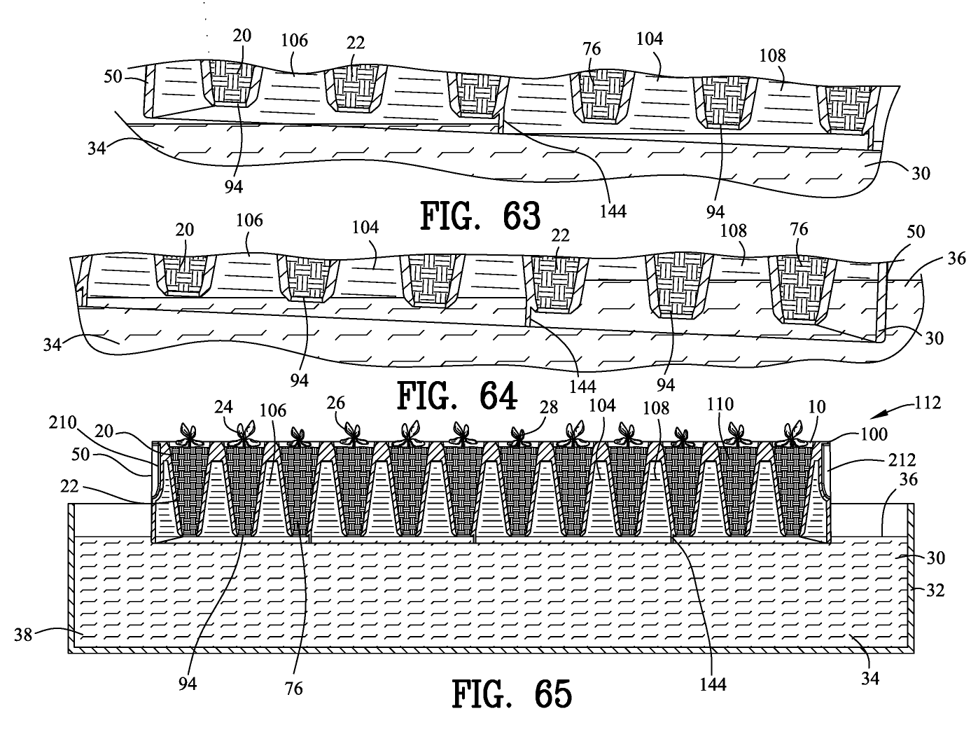

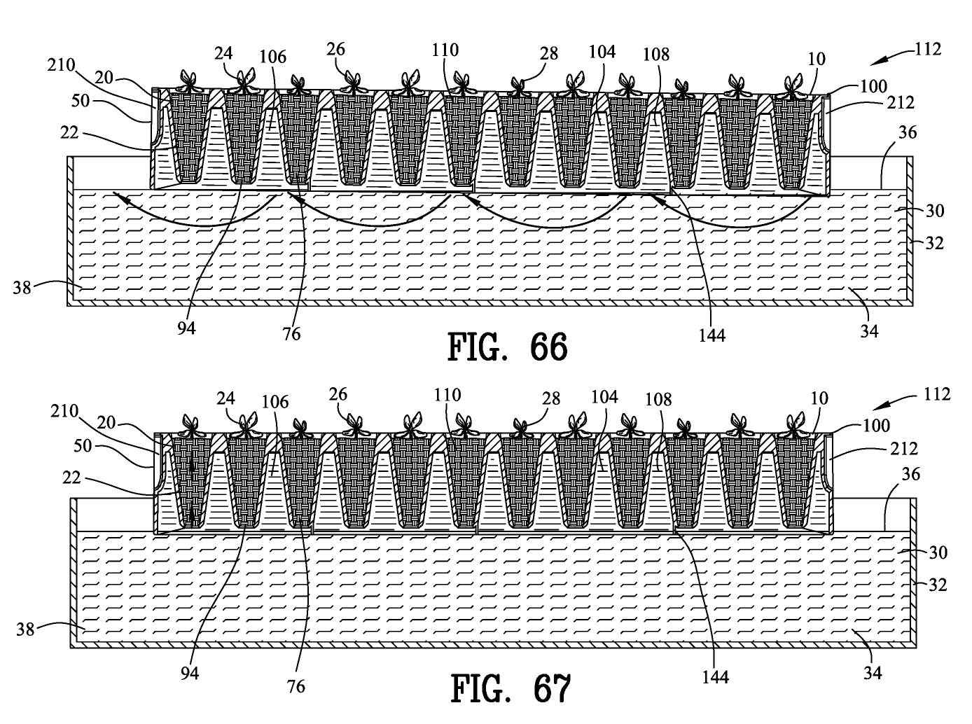

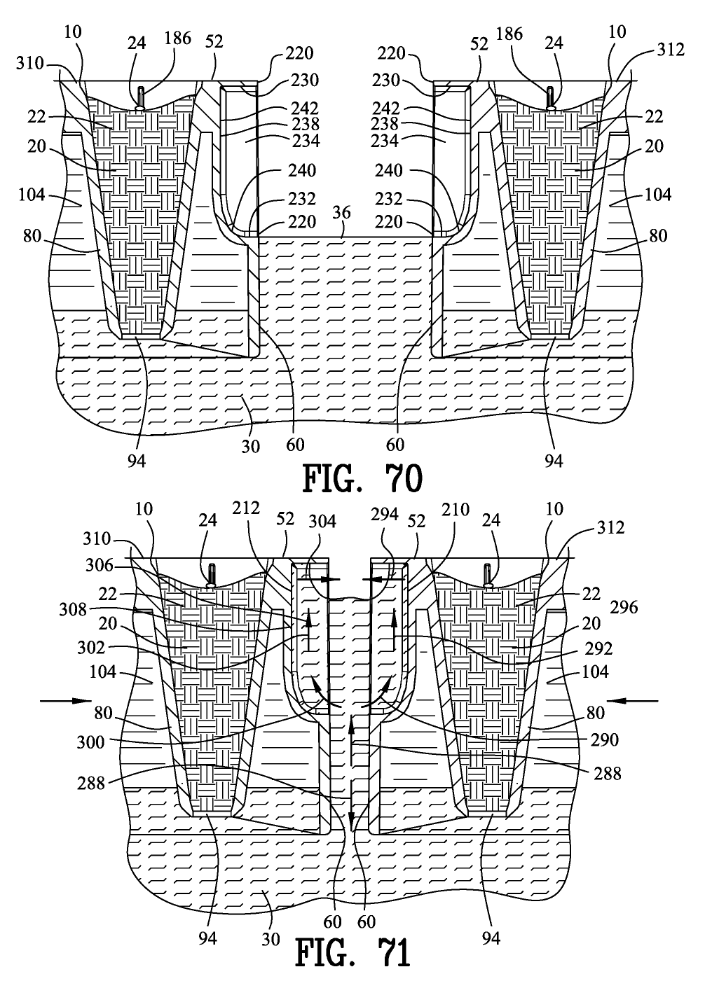

FIGS. 41-67 and FIGS. 70-71 illustrate a third embodiment of the floating growth tray 10. The floating growth tray 10 in FIGS. 41-67 and FIGS. 70-71 is similar to FIGS. 1-40 and 68-69 however includes a recessed channel 210 in the tray wall 60 extending from exterior surface 62 and into the tray chamber 70. The recessed channel 210 assists in preventing a portion of the body of water 30 from contacting the upper surface 52 of the tray plate 50 and into the soil cell chamber 92 of the plurality of soil cells 80.

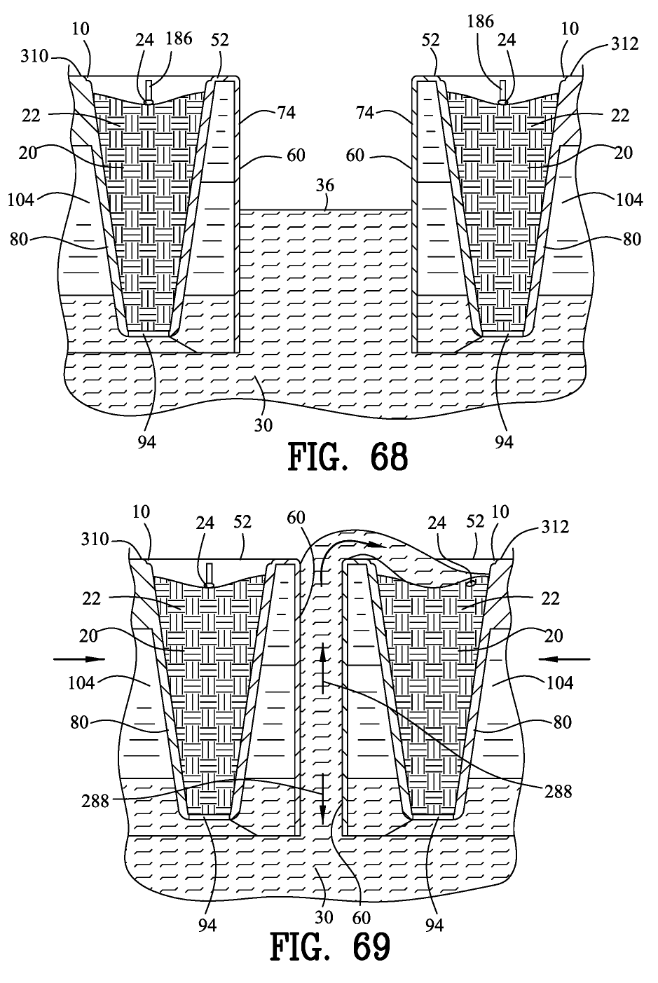

As best shown in FIGS. 68 and 69 the floating growth tray 10 in FIGS. 1-40 may cause an ascending water volume 288 and a descending water volume 288 if a first tray 310 and a second tray 312 are positioned adjacent to each other. The ascending water volume 288 may be enter into the soil cell chamber 92 to dislodge the plurality of seeds 22 and/or the plurality of seedlings 24. The dislodging or the concealment of the seeds 22 may result in poor or non-germination. Furthermore, the ascending water volume 288 may submerge the floating growth tray 10 beneath the surface of the body of water 30. The recessed channel 210 assists in redirecting the ascending water volume 288 into a horizontal orientation.

The floating growth tray 10 in FIGS. 41-67 and FIGS. 70-71 includes a first recessed channel 210 in the front side wall 130, a second recessed channel 212 in the rear side wall 132, a third recessed channel 214 in the primary side wall 134 and a fourth recessed channel 216 in the secondary side wall 136. More specifically, the floating growth tray 10 may include a first plurality recessed channels 210 in the front side wall 130, a second plurality recessed channels 212 in the rear side wall 132, a third plurality recessed channels 214 in the primary side wall 134 and a fourth plurality recessed channels 216 in the secondary side wall 136.

The recessed channel includes a general J shape channel 242 for directing the body of water 30 and in a general horizontal direction 294, 304 and away from the tray wall 60. The general J shape channel 242 may have an upper edge 220, a lower edge 222, a first edge 224 and a second edge 226. The general J shaped channel 242 further includes an upper recess wall 230, a recess back wall 238, a lower accurate wall 240, a lower recess wall 232, a first recess side wall 234 and a second recess side wall 236. The lower recess wall 232, the lower accurate wall 240, the recess back wall 238 and the upper recess wall 230 produces a first general J shape water vector 296 from the first tray 310 and a second general J shape water vector 306 from the second tray 312 for directing the body of water 30 away from the tray wall 60. The first general J shape water vector 296 from the first tray 310 and the second general J shape water vector 306 assist in preventing the ascending water volume 288 from entering into the soil cell chamber 92 and dislodging the plurality of seeds 22 and/or the plurality of seedlings 24. More specifically, the first general J shape water vector 296 may consist of a first accurate water vector 290, a first vertical recessed water vector 292 and a first horizontal water vector 294. The second general J shape water vector 306 may consist of a second accurate water vector 300, a second vertical recessed water vector 302 and a second horizontal water vector 304.

The first general J shape water vector 296 from the first tray 310 and a second general J shape water vector 306 serve to cushion an impact between the first tray 310 and the second tray 312. It should be understood that since the recessed channels 210, 212, 214, 216 are located on all four sides of the floating growth tray 10 that the first tray 310 and the second tray 312 may be utilized with a third tray and a fourth tray and so on.

The third embodiment of the floating growth tray 10 as shown in FIGS. 41-67 and FIGS. 70-71 may further include a first corner recessed channel 250 between the front side wall 130 and the primary side wall 134. A second corner recessed channel 252 is positioned between the primary side wall 134 and the rear side wall 132. A third corner recessed channel 254 is positioned between the rear side wall 132 and the secondary side wall 136. A fourth corner recessed channel 256 is positioned between the secondary side wall 136 and the front side wall 130. The first corner recessed channel 250, the second corner recessed channel 252, the third corner recessed channel 254 and the fourth corner recessed channel 256 assist in preventing the body of water 30 from contacting the upper surface 52 of the tray plate 50 and into the soil cell chamber 92 of the plurality of soil cells 80. More specifically, first corner recessed channel 250, the second corner recessed channel 252, the third corner recessed channel 254 and the fourth corner recessed channel 256 directing the body of water 30 and in a general horizontal direction 294, 304 and away from the tray wall 60.

The first corner recessed channel 250, the second corner recessed channel 252, the third corner recessed channel 254 and the fourth corner recessed channel 256 may include a general non linear J shape channel 282. The general non linear J shape channel 282 may have a non linear upper edge 260, a non linear lower edge 262, a first corner edge 264 and a second corner edge 266. The general J shaped channel 242 further includes a non linear upper recess wall 270, a non linear recess back wall 284, a non linear lower accurate wall 280, a non linear lower recess wall 272, a first corner side recess wall 274 and a second corner side recess wall 276. The non linear lower recess wall 272, the non linear lower accurate wall 280, the non linear recess back wall 284 and the non linear upper recess wall 270 produces a first non linear general J shape water vector 308 from the first tray 310 and a second non linear general J shape water vector 308 from the second tray 312 for directing the body of water 30 away from the tray wall 60.

The first non linear general J shape water vector 308 from the first tray 310 and a second non linear general J shape water vector 308 from the second tray 312 assists in preventing the ascending water volume 288 from entering into the soil cell chamber 92 and dislodging the plurality of seeds 22 and/or the plurality of seedlings 24. More specifically, the first non linear general J shape water vector 308 may consist of a first accurate water vector 290, a first vertical recessed water vector 292 and a first horizontal water vector 294. The second non linear general J shape water vector 308 may consist of a second accurate water vector 300, a second vertical recessed water vector 302 and a second horizontal water vector 304.

The first non linear general J shape water vector 308 from the first tray 310 and a second non linear general J shape water vector 308 from the second tray 312 serve to cushion an impact between the first tray 310 and the second tray 312. It should be understood that since the recessed channels 210, 212, 214, 216 are located on all four sides of the floating growth tray 10 that the first tray 310 and the second tray 312 may be utilized with a third tray and a fourth tray and so on.

The present disclosure includes that contained in the appended claims as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A floating plant propagation tray for supporting soil, the soil containing a plurality of seeds and/or a plurality of seedlings, the floating plant propagation tray being support by a body of fluid, the floating plant propagation tray, comprising:
a tray plate including an upper surface, a lower surface and a peripheral edge;
a tray wall including an exterior surface, an interior surface, a proximal edge and a distal edge;
said proximal edge of said tray wall coupled to said peripheral edge of said tray plate;
said tray plate and said tray wall defining a tray chamber;
a plurality of soil cells including a tapering cross section extending between a proximal end and a distal end;
said proximal end of said plurality of soil cells coupled to said lower surface of said tray plate and defining an upper soil cell aperture;
said plurality of soil cells defining a soil cell chamber for receiving the soil and the plurality of seeds and/or a plurality of seedlings through said upper soil cell aperture;
said distal end of said plurality of soil cells including a lower soil cell aperture for inputting a portion of the body of fluid into said soil cell chamber;
said plurality of soil cells extending within said tray chamber for defining a tray volume within said tray plate, said tray wall and around said plurality of soil cells;
said plurality of soil cell chambers defining a cell volume; and
said cell volume and said tray volume defining a buoyant equilibrium condition for supporting said floating plant propagation tray, the soil and the plurality of seeds and/or a plurality of seedlings within the body of fluid.

2. A floating plant propagation tray as set forth in claim 1, wherein said cell volume having a range between 2,500 to 9,000 cubic centimeters;
said tray wall and said plurality of soil cells displacing the body of fluid and defining a trapped air volume within said tray plate, a portion of said tray wall and around a portion of said plurality of soil cells; and
said trapped air volume have a range between 2,500 to 15,000 cubic centimeters.

3. A floating plant propagation tray as set forth in claim 1, wherein said tray wall and said plurality of soil cells displacing the body of fluid and defining a trapped air volume within said tray plate, a portion of said tray wall and around a portion of said plurality of soil cells; and
said cell volume and said trapped air volume have a ratio between 1 to 1, 1 to 2, 1 to 3, 1 to 4, 1 to 5 or 1 to 6.

4. A floating plant propagation tray as set forth in claim 1, wherein said tray wall includes a front side wall, a rear side wall, a primary side wall and a secondary side wall;
a plurality of primary bulkheads extending between said front side wall and said rear side wall for defining a plurality of primary air chambers within said tray chamber and
said plurality of primary air chambers resisting air from departing from said tray chamber upon said tray plate have a non-parallel position relative to the body of fluid.

5. A floating plant propagation tray as set forth in claim 1, wherein said tray wall includes a front side wall, a rear side wall, a primary side wall and a secondary side wall;
a plurality of secondary bulkheads extending between said primary side wall and said secondary wall for defining a plurality of secondary air chambers within said tray chamber; and
said plurality of secondary air chambers resisting air from departing from said tray chamber upon said tray plate have a non-parallel position relative to the body of fluid.

6. A floating plant propagation tray as set forth in claim 1, wherein said tray wall includes a front side wall, a rear side wall, a primary side wall and a secondary side wall;
a plurality of primary bulkheads extending between said front side wall and said rear side wall for defining a plurality of primary air chambers within said tray chamber,
a plurality of secondary bulkheads extending between said primary side wall and said secondary wall for defining a plurality of secondary air chambers within said tray chamber;
said plurality of primary bulkheads and said plurality of secondary bulkheads defining a grid of air chambers including a plurality of individual row air chambers and a plurality of individual column air chambers; and
said grid of air chambers resisting air from departing from said tray chamber upon said tray plate have a non-parallel position relative to the body of fluid.

7. A floating plant propagation tray as set forth in claim 6, wherein said grid of air chamber includes a range between 8 air chambers and 84 air chambers.

8. A floating plant propagation tray as set forth in claim 1, further including a cell bulkhead extending between said interior surface of said tray wall and each plurality of soil cells adjacent to said tray wall for defining a plurality of peripheral chambers; and
said plurality of peripheral chambers resisting air from departing from said tray chamber upon said tray plate have a non-parallel position relative to the body of fluid.

9. A floating plant propagation tray as set forth in claim 1, wherein said plurality of soil cells includes a generally square tapering cross section portion and a generally conical tapering cross section portion;
said generally square tapering cross section portion extending from said proximal end to an adjacent point of said distal end of said plurality of soil cells;
said generally conical tapering cross section portion extending from said distal end to said adjacent point of said distal end of said plurality of soil cells; and
said generally conical tapering cross section portion reducing said cell volume for increasing the buoyancy of said floating plant propagation tray.

10. A floating plant propagation tray as set forth in claim 1, wherein said tray plate, said tray wall and said plurality of soil cells are constructed from an integral one piece unit; and
said integral one piece unit includes a density with a range between 0.8 grams/cubic centimeters and 1.0 grams/cubic centimeters.

11. A floating plant propagation tray as set forth in claim 1, wherein said tray plate, said tray wall and said plurality of soil cells are constructed from an integral one piece unit; and
said integral one piece unit includes a thermoplastic polymer.

12. A floating plant propagation tray as set forth in claim 1, wherein said tray wall has a wall height;
said plurality of soil cells have a cell height;
said cell height including a less than dimension to said wall height for increasing said tray volume and reducing said plurality of soil cells displacement within the body of fluid; and
said less than dimension having a range between 0 mm and 25 mm.

13. A floating plant propagation tray as set forth in claim 1, wherein said plurality of soil cells includes a plurality of vertical root training ribs extending into said soil cell chambers for promoting the vertical growth of the plurality of seedlings.

14. A floating plant propagation tray for supporting soil, the soil containing a plurality of seeds and/or a plurality of seedlings, the floating plant propagation tray being support by a body of fluid, the floating plant propagation tray, comprising:
a tray plate including an upper surface, a lower surface and a peripheral edge;
a tray wall including an exterior surface, an interior surface, a proximal edge and a distal edge;
said proximal edge of said tray wall coupled to said peripheral edge of said tray plate;
said tray plate and said tray wall defining a tray chamber;
a plurality of soil cells including a tapering cross section extending between a proximal end and a distal end;
said proximal end of said plurality of soil cells coupled to said lower surface of said tray plate and defining an upper soil cell aperture;
said plurality of soil cells defining a soil cell chamber for receiving the soil and the plurality of seeds and/or a plurality of seedlings through said upper soil cell aperture;
said distal end of said plurality of soil cells including a lower soil cell aperture for inputting a portion of the body of fluid into said soil cell chamber;
said plurality of soil cells extending within said tray chamber for defining a tray volume within said tray plate, said tray wall and around said plurality of soil cells;
said plurality of soil cell chambers defining a cell volume;
said cell volume and said tray volume defining a buoyant equilibrium condition for supporting said floating plant propagation tray, the soil and the plurality of seeds and/or a plurality of seedlings within the body of fluid; and
a recessed channel in said tray wall extending from exterior surface and into said tray chamber for preventing the body of water from contacting said upper surface of said tray plate and into said soil cell chamber of said plurality of soil cells.

15. A floating plant propagation tray as set forth in claim 14, wherein said tray wall includes a front side wall, a rear side wall, a primary side wall and a secondary side wall; and
said recessed channel includes a first recessed channel in said front side wall, a second recessed channel in said rear side wall, a third recessed channel in said primary side wall and a fourth recessed channel in said secondary side wall.

16. A floating plant propagation tray as set forth in claim 14, wherein said tray wall includes a front side wall, a rear side wall, a primary side wall and a secondary side wall; and
said recessed channel includes a first plurality recessed channel in said front side wall, a second plurality recessed channel in said rear side wall, a third plurality recessed channel in said primary side wall and a fourth plurality recessed channel in said secondary side wall.

17. A floating plant propagation tray as set forth in claim 14, wherein said recessed channel includes a general J shape channel for directing the body of water in a general horizontal direction and away from said tray wall.

18. A floating plant propagation tray as set forth in claim 14, wherein said recessed channel includes a general J shape having an upper recess wall, a recess back wall, a lower accurate wall, a lower recess wall, a first recess side wall and a second recess side wall;
said lower recess wall, said lower accurate wall, said recess back wall and said upper recess wall producing a general J shape water vector for directing the body of water away from said tray wall.

19. A floating plant propagation tray as set forth in claim 14, wherein said tray wall includes a front side wall, a rear side wall, a primary side wall and a secondary side wall; and
a first corner recessed channel between said front side wall and said primary side wall, a second corner recessed channel between said primary side wall and said rear side wall, a third corner recessed channel between said rear side wall and said secondary side wall and a fourth corner recessed channel between said secondary side wall and said front side wall for preventing the body of water from contacting said upper surface of said tray plate and into said soil cell chamber of said plurality of soil cells.

20. A floating plant propagation tray as set forth in claim 19, wherein said first corner recessed channel, said second corner recessed channel, said third corner recessed channel and said fourth corner recessed channel includes a general non linear J shape having an non linear upper recess wall, a non linear recess back wall, a non linear lower accurate wall, a non linear lower recess wall, a first corner side recess wall and a second corner side recess wall; and
said non linear lower recess wall, said non linear lower accurate wall, said non linear recess back wall and said non linear upper recess wall producing a non linear general J shape water vector for directing the body of water away from said tray wall.
